(19) United States
(12) Patent Application Publication
(10) Pub. No.: US 2025/0140855 A1
(43) Pub. Date: May 1, 2025

(54) MXene Textile Energy Storage Devices

(71) Applicant: Drexel University, Philadelphia, PA (US)

(72) Inventors: Magdalena Karolina Zywolko, Olsztyn (PL); Yury Gogotsi, Ivyland, PA (US); Corey Alexander Inman, Santa Barbara, CA (US); Kyle Matthews, Bensalem, PA (US); Lingyi Bi, Qingdao (CN)

(21) Appl. No.: 18/926,468

(22) Filed: Oct. 25, 2024

Related U.S. Application Data
(60) Provisional application No. 63/593,139, filed on Oct. 25, 2023.

(51) Int. Cl. H01M 4/60; D06M 11/71; D06M 11/74; D06M 101/06; H01M 10/44; H01M 50/211; H01M 50/247; H02J 7/00

(52) U.S. Cl. CPC H01M 4/60; D06M 11/71; D06M 11/74; H01M 10/441; H01M 50/211; H01M 50/247; H02J 7/0063; D06M 2101/06; D06M 2200/00; H01M 2220/30

(57) ABSTRACT

An energy storage cell, comprising: a layer comprising a plurality of fibers, the plurality of fibers having a MXene material disposed thereon; an electrolyte disposed on the layer; a first conductor in electronic communication with the electrolyte; and a second conductor in electronic communication with the electrolyte. Energy storage devices, the energy storage device comprising at least one energy storage cell according to the present disclosure. A method, comprising the use of an energy storage device according to the present disclosure.

### RELATED APPLICATIONS

The present application claims priority to and the benefit of U.S. patent application No. 63/593,139, “MXene Textile Energy Storage Devices” (filed Oct. 25, 2023). All foregoing applications are incorporated herein by reference in their entireties for any and all purposes.

### TECHNICAL FIELD

The present disclosure relates to the field of MXene materials and to the field of energy storage components.

### BACKGROUND

Existing approaches to wearable electronics can suffer from power supplies that last for only a short time. Accordingly, there is a long-felt need for improved energy storage cells useful in wearable and similar applications.

### SUMMARY

In meeting the described long-felt needs, the present disclosure provides an energy storage cell, comprising: a layer comprising a plurality of fibers, the plurality of fibers having a MXene material disposed thereon; an electrolyte contacting on the layer; a first conductor in electronic communication with the electrolyte; and a second conductor in electronic communication with the electrolyte.

Also provided are energy storage devices, the energy storage device comprising at least one energy storage cell according to the present disclosure.

Also provided is a method, wherein the method comprises charging or discharging a cell according to the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1A provides an exploded view of a component according to the present disclosure.

FIG. 1B provides exemplary data (left) and exemplary circuitry (right) according to the present disclosure.

FIG. 2 provides further depiction of the disclosed technology.

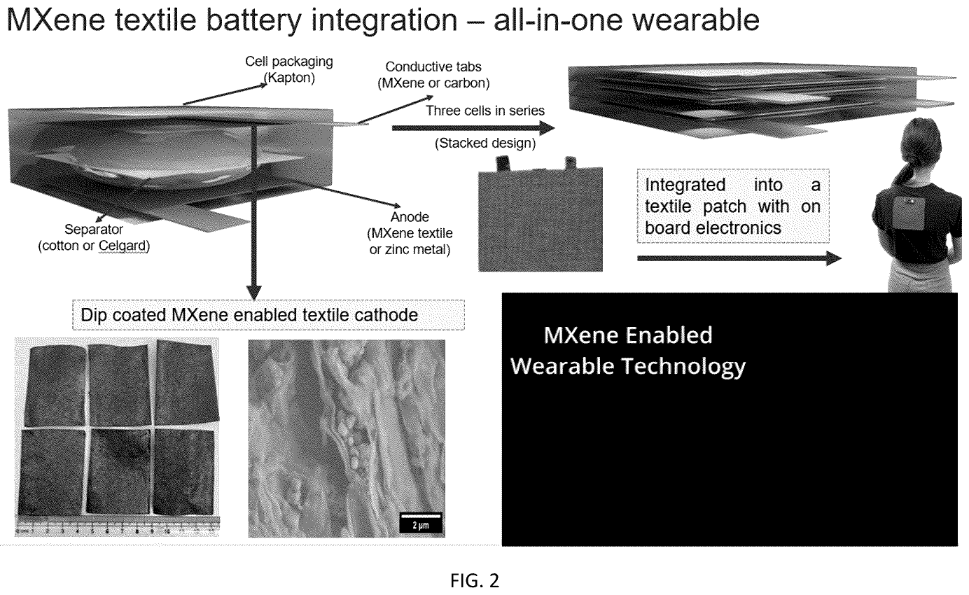

FIG. 3. (a) Schematic of MXene synthesis through selective etching using HF/HCl mixed acid etchants. (b) Vacuum-assisted filtration setup and a vacuum-filtered film. (c) Blade-coated MXene film. (d) WiS electrolytes—5 m KI 15 m ZnCl₂ and 1 m LiCl 15 m ZnCl₂.

FIG. 4. LFP electrodes preparation schematic.

FIG. 5. (a) Water-based slurry formulations of LFP:MXene used in the experiments. (b) LFP:MXene electrodes preparation schematic.

FIG. 6. Schematic of binder stability test for 70:10:20 and 50:50 electrodes.

FIG. 7. (a) 2-point probe resistance measurement. (b) LFP:MXene textile strip of length:width ratio equal to 10 with different lengths indications for the conductivity test.

FIG. 8. (a) The Swagelok assembly of LFP and LFP:MXene electrodes in the 3-cell setup (with separate reference). (b) 2-cell setup (without separate reference).

FIG. 9. Pouch cell assembly for (a) a single cell, 3 cells in series in (b) stacked and (c) planar design.

FIG. 10. (a) Cable soldering to Arduino Nano BLE Sense. (b) The schematic showing the battery-device integration.

FIG. 11. Characterization of d-Ti₃C₂Tₓ. (a) Concentrated ink. (b) XRD pattern of the free-standing film. (c) Raman spectroscopy of the free-standing film. The diluted solution (c) UV-vis, (d) DLS, (e) zeta potential measurements. (f) Dip-coated textiles. (g) The SEM images of dip-coated textiles at 100× and 2kX magnifications.

FIG. 12. (a) The XRD pattern of LFP powder. 70:10:20 electrode cast on a CFP. (b) Secondary electron SEM image at 100× magnification. (c) Secondary (left) and backscattered (right) SEM image at 6kX magnification. (d) Optical microscopy image at 5× magnification.

FIG. 13. LFP:MXene dip-coated textiles characterization. (a) 50:50 dip-coated electrodes. (b) The XRD pattern for all samples-MXene, 20:80, 50:50, and 80:20 textiles, LFP powder. (c) The SEM images at 4.5kX (top left), 5kX (top right), 11kX (bottom left) and 13kX (bottom right) magnifications. (d) Optical microscopy images at 5× (left), and 20× (right) magnifications.

FIG. 14. Stability test in 1 m LiCl 15 m ZnCl₂ WiS electrolyte for: (a) 70:10:20 electrode, left-pristine, middle-after 5 days, right-after 15 days. (b) 50:50 electrode, left-pristine, middle-after 5 days, right-after 15 days

FIG. 15. Samples of three ratios-20:80, 50:50, 80:20. (a) The active material mass loading and conductivity change in the function of the number of dips. (b) The active material density in the function of the number of dips.

FIG. 16. (a) The mechanism of the ReHAB Zn/LFP system. (b) Individual electrodes and cell potential determination in the spectator cell setup.

FIG. 17. The Cyclic Voltammetry curves at 0.1 mV s⁻¹ of LFP:CB:CMC/SBR low mass loading electrodes (a) 86:9:5, (b) 80:10:10, (c) 70:10:20. The gravimetric capacity vs cycle number test for (d) low mass loading electrodes, (e) high mass loading electrodes. The areal capacity vs cycle number test for (f) low mass loading electrodes, (g) high mass loading electrodes.

FIG. 18. The Cyclic Voltammetry curves at 0.1 mV s⁻¹ of LFP:MXene low mass loading electrodes (a) 20:80, (b) and (c) 50:50 at different mass loadings, and (d) 80:20. The gravimetric capacity vs cycle number tests for (e) low mass loading electrodes, (f) high mass loading electrodes. The areal capacity vs cycle number test for (g) low mass loading electrodes, (h) high mass loading electrodes.

FIG. 19. (a) The areal capacity vs. cycle number tests for 50:50 ratio with different mass loadings. (b) The rate test for 50:50 ratio with 3.7 mg cm⁻² mass loading. The comparison between 50:50 and 70:10:20 with similar mass loading: (c) areal capacity and CE vs cycle number, (d) gravimetric capacity per electrode mass vs cycle number.

FIG. 20. Pouch single cell electrochemical tests: (a) two cells of the same mass loading and similar footprint area, (b) two cells of different mass loading and the same footprint area, (c) rate test for 4.6 mg cm⁻² mass loading cell.

FIG. 21. Pouch cell electrochemical tests: (a) two cells in series, (b) three cells in series (for powering devices).

FIG. 22. The potentiostatic study of the current draw for: (a) Arduino Nano BLE Sense, (b) Arduino Mini, (c) Fitbit Charge 5, (d) Casio LCD watch, (e) comparison of all electronic devices.

FIG. 23. Battery integration schematic-programming Arduino, integration with the battery (wearable sensing platform), wireless connection and communication, data recording and processing.

FIG. 24. (a) The OCV curve representing the voltage change over time before and after integration with Casio LCD watch. (b) The successful integration of the battery with the watch, resulting in the activation of the device.

FIG. 25. (a) The OCV curve representing the voltage change over time before and after integration with Arduino Nano BLE Sense equipped with environmental sensors. (b) Data collection from the environmental sensors. (c) The successful integration of the battery with the Arduino.

FIG. 26. (a) Demonstration of the wearable sensing platform comprising Arduino Nano BLE IoT and the accelerometer sensor. (b) Motion tracking data collection from the Arduino: (c) walking, (d) squatting, (e) arm twisting, (f) toe touching.

FIG. 27. Zn plating/stripping at 1 mA cm⁻² with a deposition capacity of 0.5 mAh cm⁻² in a 1 m LiCl 15 m ZnCl₂ WiS. (a) The galvanostatic cycling of a Zn∥Zn, Zn∥MXene film and Zn∥MXene textile cells. (b) Coulombic efficiency of MXene film and MXene textile. (c) Potential vs. areal capacity curve of the selected cycles for MXene textile. (d) Potential vs. areal capacity curve of the selected cycles for MXene textile.

FIG. 28. Zn plating/stripping at 1 mA cm⁻² with a deposition capacity of 1 mAh cm⁻² in a 1 m LiCl 15 m ZnCl₂ WiS. (a) The galvanostatic cycling of a Zn∥Zn, Zn∥MXene film and Zn∥MXene textile cells. (b) Coulombic efficiency of MXene film and MXene textile. (c) Potential vs. areal capacity curve of the selected cycles for MXene textile. (d) Potential vs. areal capacity curve of the selected cycles for MXene textile.

FIG. 29. Dual plating test for Ti₃C₂Tₓ MXene film WE and Zn foil pseudoreference (cathode-free) in 5 m KI 15 m ZnCl₂. (a) Potential vs. areal capacity curve for the selected cycles. (b) Discharge capacity and CE vs. cycle number. (c) The CV curve comparison of two cells: (1) Ti₃C₂Tₓ MXene textile WE and Ti₃C₂Tₓ MXene film CE, (2) Ti₃C₂Tₓ MXene textile WE and Ti₃C₂Tₓ MXene textile CE.

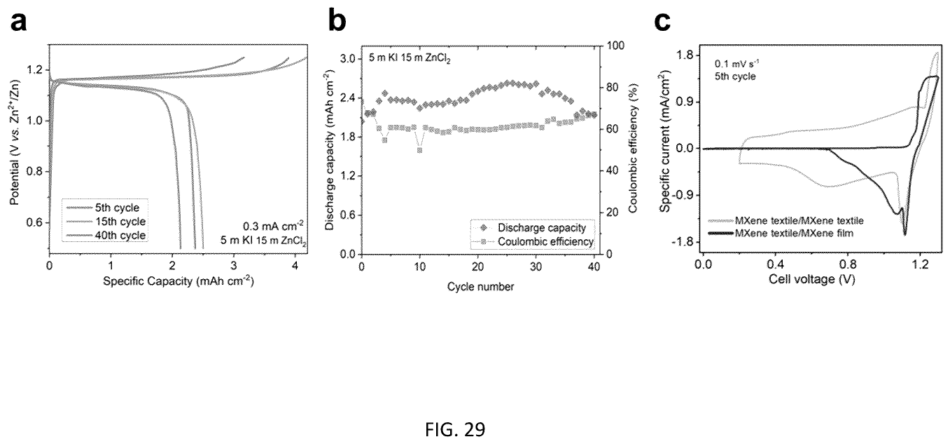

FIG. 30. Optical microscopy of before and after plating images (a) the iodide electrode at 5×, 20×, and 50× magnifications (from the left to the right), (b) the zinc electrode at 10×, 10×, and 50× magnifications (from the left to the right).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

The disclosed technology provides, in some embodiments, wearable battery technology, which by utilizing flexible electrodes enclosed in a textile-based packaging, offers a comfortable and compliant rechargeable power supply for future electronic on-garment applications-wearable electronics.

The described wearable energy storage technology is facilitated by the use of solution-processed two-dimensional MXenes (Ti₃C₂Tₓ). Due to the hydrophilic surface of MXenes as well as their robustness, they can be integrated very well into natural fabrics (e.g., cotton) to form flexible textile-based electrodes. To produce battery-like behavior of these electrodes-MXene, in the form of an ink, was mixed with an electrochemically active component (e.g., lithium iron phosphate-LFP) that can undergo lithium intercalation/deintercalation delivering a significant capacity. LFP is used as the electrochemically active component that is a preferable cathode materials for lithium-ion batteries due to its low cost, long lifespan and relatively high voltage vs Li/Lit. MXene/LFP ink was produced and dip-coated onto cotton textile samples to serve as a cathode for textile-based lithium-ion batteries. MXene serves several functions as a passive component in these electrodes:

MXenes serve as a binder for the electrochemically active component (LFP) to produce a cohesive coating.

MXenes act as the adhesive to the cotton textile due to MXenes' hydrophilicity and high affinity to natural textiles.

MXenes serve as a conductive binder allowing for the formation of an electron pathway. This is of particular importance considering the resistive nature of the active LFP particles and insulating cotton substrates.

Due to the high electrical conductivity of MXenes/LFP electrodes can be generated without the need for a current collector, unlike current wearable energy storage technologies. This can decrease one or more of the volume, mass, and rigidity of a battery.

MXenes/LFP coatings on cotton substrates are flexible.

MXene-coated textile with no active material can also serve as a host material for metal ions deposition on the anode, leading to an improved gravimetric performance (much reduced mass of the battery). In this so-called anode-free approach, the dendrites are formed in a 3D porous textile structure while maintaining superior electron percolation.

The Ti₃AlC₂ MAX was produced as previously described by Mathis et al. through the high-aluminum content protocol to obtain a higher conductivity, better stability, and less defective MXene⁵². For Ti₃C₂Tₓ MXene synthesis, the mixed HF/HCl acid etching solution protocol (2:6:12 volumetric ratio of HF:H₂O:HCl, where HF, Hydrofluoric acid, 48-51% solution in water, purchased from Acros Organics and HCl, Hydrochloric Acid, 36.5 to 38.0%, Fisher Chemical™, purchased from Fisher Scientific) was applied to obtain multilayer flakes of Ti₃C₂Tₓ (ml-Ti₃C₂Tₓ).

It should be understood that although the disclosed technology is illustrated using Ti₃C₂Tₓ MXene, the disclosed technology can include other MXenes and is not limited to Ti₃C₂Tₓ MXene. MXene compositions can be, e.g., any of the compositions described in at least one of U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015) or International Applications PCT/US2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), PCT/US2020/054912 (filed Oct. 9, 2020), or PCT/US2016/028,354 (filed Apr. 20, 2016), preferably where the MXene composition comprises titanium and carbon (e.g., Ti₃C₂, Ti₂C, Mo₂TiC₂, and the like). MXenes that include transition metals (e.g., Ti, Mo, Nb, Va, Cr) are considered suitable. Each of these compositions is considered an independent embodiment.

MXenes adopt three structures with one metal on the M site, as inherited from the parent MAX phases: M₂C, M₃C₂, and M₄C₃. They can be produced by selectively etching out the A element from a MAX phase or other layered precursor (e.g., Mo₂Ga₂C), which has the general formula Mₙ₊₁AXₙ, where M is an early transition metal, A is an element from group 13 or 14 of the periodic table, X is C and/or N, and n=1-4.

Double transition metal MXenes can take two forms, ordered double transition metal MXenes or solid solution MXenes. For ordered double transition metal MXenes, they have the general formulas: M′₂M″C₂ or M′₂M″₂C₃ where M′ and M″ are different transition metals. Double transition metal carbides that have been synthesized include Mo₂TiC₂, Mo₂Ti₂C₃, Cr₂TiC₂, and Mo₄VC₄. In some of these MXenes (such as Mo₂TiC₂, Mo₂Ti₂C₃, and Cr₂TiC₂), the Mo or Cr atoms are on outer edges of the MXene and these atoms control electrochemical properties of the MXenes.

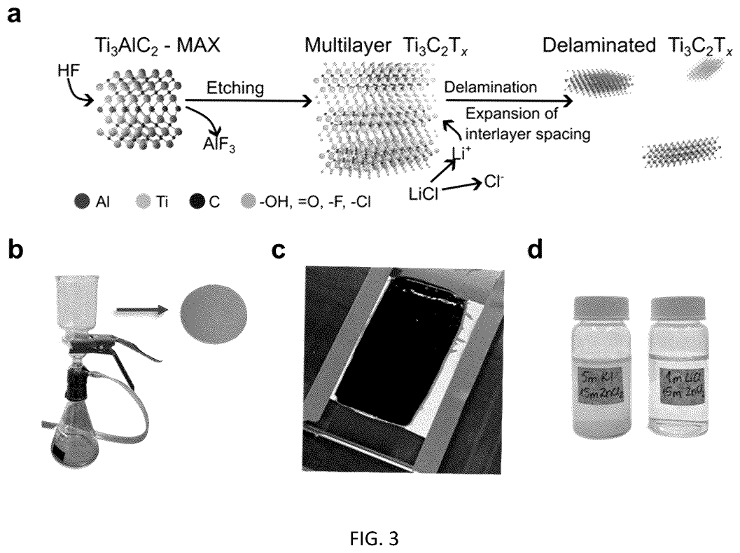

A magnetic stir bar with an appropriate length is selected concerning the diameter of the bottle. The bottle and a thermocouple were both placed in a mineral oil bath, on a magnetic hot plate. Typically, 1 g of Ti₃AlC₂ MAX phase was added at 0.2 g min⁻¹ rate to a mixture of 20 mL etchant solution (2 mL HF, 6 mL H₂O, and 12 mL HCl) at a low speed (150 rpm). Upon the addition of the powder, the solution should be stirred in a loosely capped 60 mL high-density polyethylene bottle at 300 rpm for 24 h at 35° C. to allow gas release. The reaction should initially be monitored to make sure there is no severe reaction occurring and that the bottle is placed in the center of the hot plate to ensure proper mixing. Afterward, the obtained solution was washed with deionized (DI) water via repeated centrifugation and decantation cycles at 3500 rpm for 10 min using a 175 mL centrifuge bottle until neutral pH was reached. The sediment consisting of ml-Ti₃C₂Tₓ was dispersed in 0.5 M LiCl solution−1 g LiCl in 50 mL H₂O (Lithium chloride, purchased from Alfa Aesar), and stirred at 300 rpm for 24 hours at 35° C. After ion intercalation, the MXene/LiCl solution was delaminated and washed with DI water via repeated centrifugation and decantation of the supernatant using 175 mL centrifuge bottles. The first cycle was performed at 3500 rpm for 5 min, after which the supernatant was discarded. The centrifuge bottles were again filled with DI water, dispersed via shaking, and placed in a centrifuge for an hour to remove excess LiCl. The sediment was refilled with DI water, dispersed, and ran again in a centrifuge at 3500 rpm for 10 min to collect dark-greenish color supernatant. This step has to be executed very gently to avoid mixing the supernatant with the sediment. This step was repeated until the collected supernatant solution became less opaque, and thus, less concentrated. Finally, the collected single flake MXene solution was concentrated using a high-speed centrifuge at 10,000 rpm for 10 min to obtain a highly concentrated, gel-like d-Ti₃C₂Tₓ solution and used in the studies. The synthesis schematic was shown in FIG. 3a.

A vacuum filtration setup was used to determine ink concentration, by weighing a known amount of MXene solution dispersed in water, filtering it on a Celgard 3501 membrane (further referred to as Celgard), and then weighing the obtained film (FIG. 3b). The resultant gravimetric concentration was equal to 26.6 mg g⁻¹. Moreover, MXene ink was blade-coated on Celgard to form a thin free-standing film (FIG. 3c). The electrical conductivity of vacuum-filtered and blade-coated Ti₃C₂Tₓ films was measured using a four-point probe with 1 mm probe separation (Jandel Engineering Ltd., Bedfordshire, UK). The recorded sheet resistances were then converted to electrical conductivity (S cm⁻¹) using film thickness measured by a micrometer. Five measurements of sheet resistances and thicknesses were performed, with the average being recorded. Particle size analysis and zeta potential measurements were performed using a Malvern Panalytical Zetasizer Nano ZS by pipetting 1 mL of diluted colloidal solution into a polystyrene cuvette. The zeta potential was equal to −37.4 mV in a neutral pH, which confirmed MXene colloidal stability in aqueous solutions. UV-vis spectroscopy was recorded using an Evolution 201 spectrometer (Thermo Scientific) with a 10 mm optical path length quartz cuvette, scanning from 200 to 1000 nm, at 100× sample dilution to confirm that there was no oxidation present.

### Electrolyte Preparation

### 1 m LiCl 15 m ZnCl₂

0.42 g anhydrous LiCl (Lithium chloride, purchased from Alfa Aesar) and 20.4 g anhydrous ZnCl₂ (Zinc chloride, purchased from Alfa Aesar) were mixed with 10.0 mL DI water via shaking until the salt was entirely dissolved in the solution to form a highly concentrated WiS liquid electrolyte. Since the reaction is exothermic, the bottle became warm because of the released heat. Subsequently, the mixture was allowed to cool down gradually, reaching room temperature overnight. Prior to electrochemical tests, the electrolyte was Ar-bubbled for 15 min to remove dissolved O₂.

### 5 m KI 15 m ZnCl₂

8.30 g anhydrous KI (Potassium iodide, purchased from Alfa Aesar) and 20.4 g anhydrous ZnCl₂ (Zinc chloride, purchased from Alfa Aesar) were mixed manually with 10.0 mL DI water via shaking until the salt was entirely dissolved in the solution, resulting in a highly concentrated WiS liquid electrolyte. Prior to electrochemical tests, the electrolyte was Ar-bubbled for 15 minutes to remove dissolved O₂. All electrolytes are shown in FIG. 3d.

### LFP and LFP:MXene Composite Electrode Preparation

### Slurry Fabrication and Fabric Coating

In this study, two different water-based slurries with (1) styrene-butadiene rubber (SBR) as a thickener and sodium carboxymethyl cellulose (CMC) as a binder and (2) Ti₃C₂Tₓ MXene conductive binder and additive were prepared and cast on a fiber-based current collector or coated on a commercially available nonwoven cotton substrate. In both slurries carbon-coated LFP (C-LFP), purchased from MTI and further referred to as LFP, was used as an active material. The C65 (purchased from MTI) was utilized as a conductive additive in the LFP-based electrodes. For the electrochemical characterization, both low and high active material mass loading electrodes were prepared and tested.

### LFP Electrode Preparation

Three different slurry formulations with varying binder concentrations (5%, 10%, and 20% wt) were synthesized based on the procedure reported by Noemí Aguiló-Aguayo et al., where a 1:4 ratio of CMC (purchased from MTI) to SBR (purchased from MTI) showed the best performance. In this work, their slurry formation procedure was adopted, with 35 wt % of solid material and 65 wt % water content. Water-based dried electrode formulations used in the experiments, where CMC:SBR=4 were presented in Table 1.

TABLE 1
Water-based dried LFP:CB:CMC/SBR electrode
formulations used in the experiments.
Dried electrode composition with SBR:CMC mass ratio = 4

| LFP (%) | CB (%) | CMC (%) | SBR (%) |
|---|---|---|---|
| 86 | 9 | 1 | 4 |
| 80 | 10 | 2 | 8 |
| 70 | 10 | 4 | 16 |

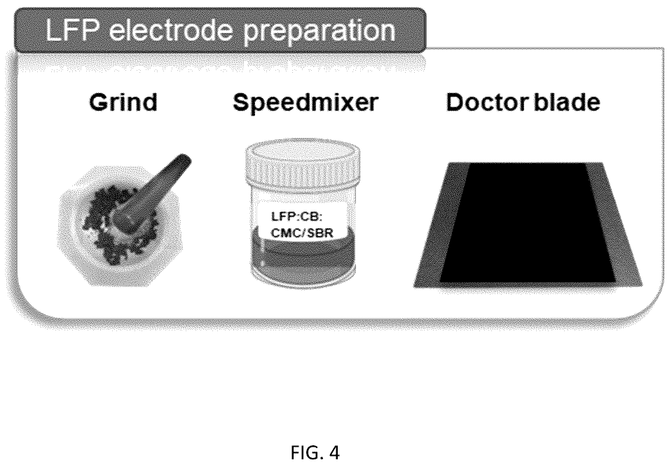

The slurries were prepared by soaking a desired amount of CMC in deionized water overnight at room temperature to maximize its volume. Next, LFP and carbon black were thoroughly mixed in a mortar with a pestle for 10 minutes until homogeneity was achieved. Subsequently, SBR was added to the mixture along with LFP and CB. The cup containing the components was placed in a Flacktek speed-mixer machine (Mazerustar, KK-250S, Kurabo, Japan) and stirred at 3500 rpm for 10 minutes. Based on the visual observation, a few droplets of water were added to make slurries denser. Before casting the slurries, the carbon fiber paper (CFP) substrate was treated to remove impurities and increase its hydrophilicity. It was initially bath-sonicated in ethanol for 15 minutes and then in water. Next, plasma treatment was carried out with an intermediate O₂/Ar flow for 5 minutes to introduce more-OH terminations. The slurries were finally cast onto the CFP using a doctor blade at a gap distance of 75 um (FIG. 4). The electrodes were first pre-dried at room temperature for 6 hours and then in an argon vacuum oven at 80° C. for 12 hours.

### LFP:MXene Electrode Preparation

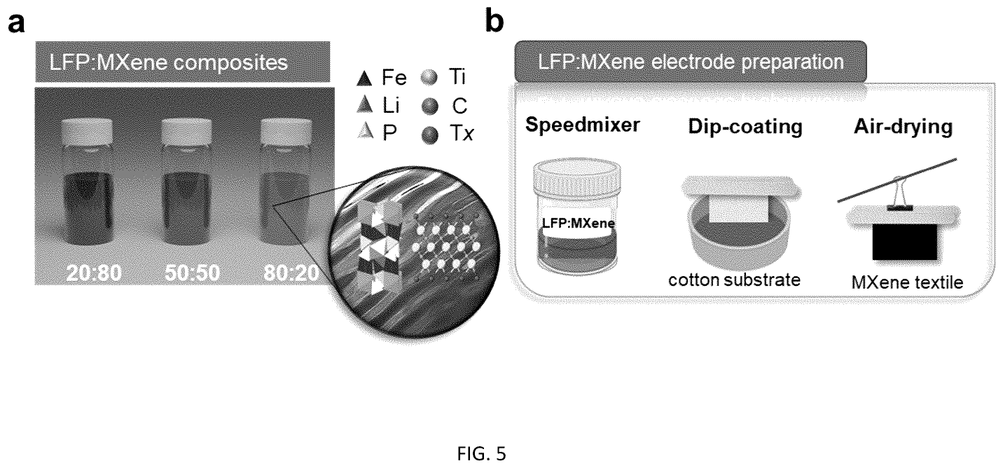

Firstly, three ratios of LFP:MXene samples were synthesized—20:80, 50:50, and 80:20—which corresponded to the mass of carbon-coated LFP powder and a previously reported 26.6 mg g⁻¹ MXene ink (FIG. 5a). The mixtures were prepared in a plastic cup and formed into slurries using a FlackTek Speedmixer at 3500 rpm for 5 minutes. The mass of the thin nonwoven cotton substrate of approximately 30 cm² area was recorded prior to dip-coating.

To increase hydrophilicity, the cotton substrates were plasma-treated with an intermediate O₂/Ar flow for 5 minutes to introduce more-OH terminations and enhance ink infiltration and adhesion. To prevent MXene oxidation, the freshly prepared aqueous LFP:MXene ink was immediately used for coating purposes. Each cotton substrate was immersed in the ink for at least 30 seconds on each side, excess solution was removed, and they were left to dry at room temperature for 12 hours (FIG. 5b). After coating, all cotton fabric substrates were measured and weighed to record the mass change to determine the active material areal mass loading per surface area (mg cm⁻² _{LFP}).

### Binder Stability

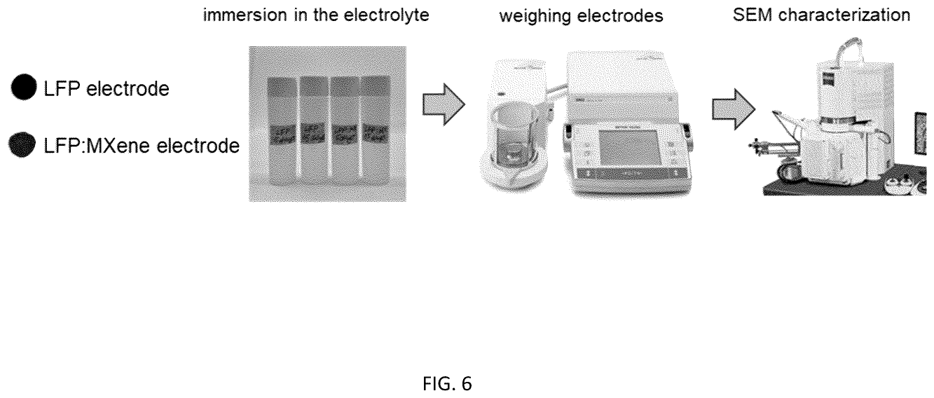

Both binders used in this exemplary study, CMC: SBR and MXene, underwent environmental stability tests before the electrochemical testing to assess their practicality for use in the 1 m 15 m ZnCl₂ electrolyte. Three 3 mm discs of both LFP and LFP:MXene-based electrodes, with similar active material mass loading (for LFP and LFP:MXene-based electrode), were punched and weighed. One disc of each type (pristine) served as a reference and was not immersed in the electrolyte. The other two discs were placed in separate 5 ml vials filled with the electrolyte. The mass loss was recorded after 5 and 15 days. Before the mass measurement, each electrode was gently treated with water to remove the electrolyte from its porous form factor. Their visual appearance was characterized using SEM (Scanning Electron Microscope). The schematic of the binder stability test was shown in FIG. 6.

### Active Material Mass Loading and Conductivity Measurements.

To achieve the desired loading, dip-coating can be repeated as many times as necessary. A parametric study evaluating the relation between a number of dips from 1 to 6 and active material mass loading, together with the conductivity, has been performed. All six cotton fabric substrates were of the same dimensions and weight. A sufficient amount of LFP:MXene slurry was prepared before dip-coating. Since each substrate had a different number of dips, therefore upon coating, their thickness was measured at least 5 times using a micrometer to record an average value. Afterward, the coated substrates were weighed again to record the increase in mass. The total mass increase was recalculated per each square centimeter of the substrate, taking into account its pristine mass (4 mg per cm² of fabric). Finally, the areal mass loading per surface area was obtained including the wt % of active material (_{LFP} mg cm⁻²).

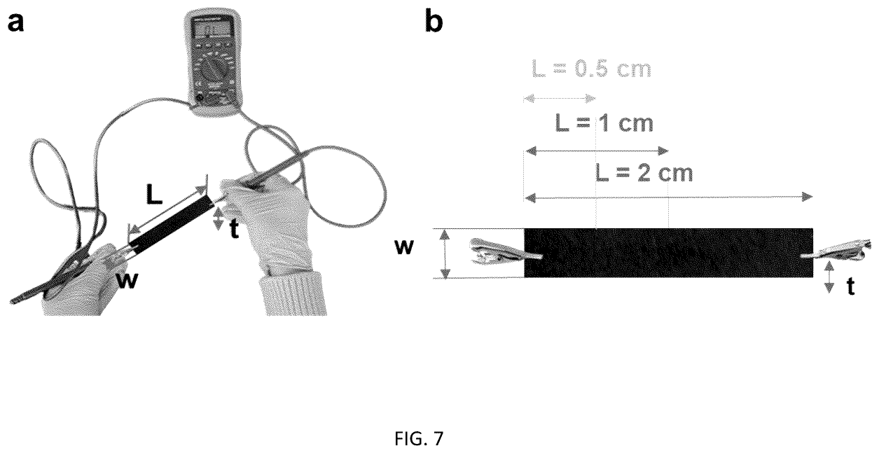

The resistance (Ω) of all 3D textile-based samples was measured using a two-point probe (Crenova, 8233D digital multimeter) and transformed to material resistivity (ρ) using Equation 1, where length (L) to width (W) factor was fixed. The aspect ratio was equal to 10 to define sample geometry, e.g. L was 2 cm and W 2 mm (FIG. 7a). Each time, the probe was localized at 2, 1, and 0.5 cm separation distance. The resistance was recorded at least 3 times (FIG. 7b). Using a fitting curve and extrapolating the linear function, the contact resistance was obtained. The contact resistance was subtracted from the resistance values that were acquired at a 2 cm distance and, converted into electrical conductivity (o) using Equation 2.

$$ρ = Ω \frac{A}{L} = Ω \frac{Wt}{L} = Ω \frac{t}{10} \qquad ( Equation 1 )$$

$$σ = \frac{1}{ρ} \qquad ( Equation 2 )$$

where: ρ is material resistivity (Ω cm⁻¹), L is the length (cm), A is the cross-sectional area (cm²), which can be split into: width W (cm), thickness T (cm) and σ is electrical conductivity (S cm⁻¹).

### Material Characterization

A Rigaku Smartlab X-ray diffractometer operating at 40 kV and 30 mA with Cu K-alpha radiation was used to record XRD patterns. MXene free-standing film, LFP powder, and LFP:MXene electrodes were placed on a silica substrate and scanned from 3-70 degrees, with a step scan of 0.02 degrees and a speed of 2 degrees per minute. The morphology and structure of textile-based samples were analyzed using an optical microscope (VK-8510, KEYENCE) and scanning electron microscopy (Zeiss Supra 50VP). Raman spectra were recorded using a reflection mode Renishaw InVia dispersive spectrometer (Renishaw plc, Gloucestershire, UK) with a laser excitation of 785 nm (for Ti₃C₂Tₓ), grating 1,200 g mm⁻¹ and 10% laser power to check if MXene oxidized after performing electrochemical tests at high potential.

### Electrochemical Testing

The electrochemical tests, including cyclic voltammetry (CV), galvanostatic charge-discharge (GCD), and rate capability tests were conducted at room temperature using a VMP3 BioLogic variable multichannel potentiostat. Initially, the spectator mode in a three-cell configuration was employed to determine the redox potentials of both the anode and cathode in a 1 m LiCl 15 m ZnCl₂ WiS electrolyte. The electrochemical potential window was defined based on experimental results and existing literature. To ensure suitable conditions, a plastic Swagelok cell equipped with glassy carbon electrodes (GCE) was selected as the most suitable setup for a chloride-containing electrolyte.

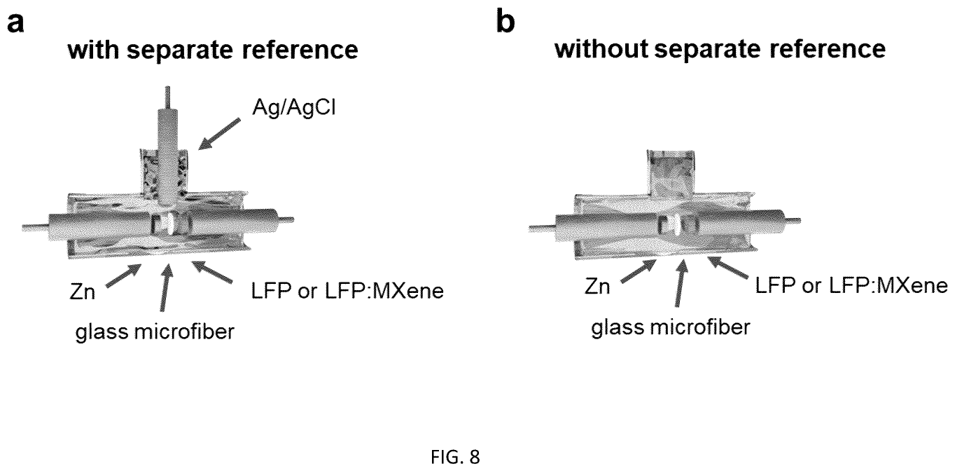

The synthesized materials (LFP and LFP:MXene) were designated as the working electrode (WE), Zn foil (100 μm, purity 99.99%, Advent Research Materials) as the counter electrode (CE), and Ag/AgCl (3 M KCl) as the reference electrode (RE), with a glass fiber separator. It is important to ensure that the separator covers the entire area of the CE. A 3 mm (0.071 cm²) disc was punched for the WE and a 5 mm disc for the CE. However, for most tests, a two-cell configuration was used, where Zn foil served as both a pseudo-reference and a CE. Both setups for the electrochemical tests are presented in FIG. 8. Different active material ratios of LFP and LFP:MXene in the already prepared electrodes were utilized for the electrochemical tests. From the results, electrode architectures in terms of ratio was defined and various mass loadings were tested.

### Cyclic Voltammetry

Potentiostatic testing was used to test the electrochemical window, the kinetics of the oxidation/reduction reactions, and their stability and cyclability. The measurements were performed at a scan rate of 0.1 mV s⁻¹ and a potential sweep from 0.8 to 1.4 V for LFP and LFP:MXene electrodes (vs. Zn). The electrodes were first oxidized by applying positive potentials and then reduced until the lower voltage limit was reached. The capacity was calculated using EC-Lab software by integrating the area under the I vs. E discharge curve and dividing it by the scan rate. Those values were subsequently transformed into gravimetric and areal capacities using Equations 3 and 4.

$$Specific gravimetric capacity ( mAh {g}^{- 1} ) = \frac{C}{3.6 \cdot m} \qquad ( Equation 3 )$$

$$Specific areal capacity ( mAh {cm}^{- 2} ) = \frac{C}{3.6 \cdot A} \qquad ( Equation 4 )$$

where C is the capacity (A·s), 3.6 is the conversion from seconds to hours, m is the mass of the active material (grams) and A is the area of the working electrode (cm²).

Galvanostatic charge discharge with potential limitation (GCPL)

Galvanostatic testing was conducted to identify the charge/discharge profiles of LFP:MXene system half-cells. All experiments started with a positive current forcing the Li ions to deintercalate from the positive electrode and Zn ions to plate on the negative electrode in order to fully charge the cell and afterward, the cell was discharged. Rate capability experiments were conducted for 5 cycles each at specific currents normalized by active material mass and corresponding to the discharge time C/10, C/5, C/2 1C, and again C/10, where 1C means that the current will discharge the battery in 1 hour.

The efficiency of the working electrode to reversibly charge/discharge was described by coulombic efficiency can be calculated using Equation 5:

$$( Equation 5 )$$

$$Coulombic efficiency ( \% ) = \frac{charge capacity of cycle n}{discharge capacity of cycle n} \cdot 100 \%$$

The electric energy stored in a battery cell or battery pack can be calculated using Equation 6. It shows the capacity of the battery to provide electric energy for a prolonged time.

$$Areal energy density ( mWh {cm}^{- 2} ) = \frac{i}{A} {\int }_{0}^{{t}_{d}} V dt \qquad ( Equation 6 )$$

where V is the battery cell voltage (V), i is the absolute value of the applied current (mA), t_{d} is the time to reach the discharge voltage limit (hours), and A is the device footprint area (cm²).

### Textile-Based Device-Battery Configuration

To create a fully wearable energy storage system, the utilization of flexible electrodes is relevant. Additionally, for an optimal user experience and practicality, it is preferable to incorporate a textile-based material as a cell/pack packaging. In this study, self-adhesive coarse linen patches were employed in the device fabrication to serve as packaging for the large-area electrodes. This choice allows for easy handling and accommodates different size demands of the system providing good wearability and comfort.

While ensuring the functionality of the energy storage system, flexible and mechanically robust graphite foil deposited on a thin polymer substrate (0.025 mm Grafoil Carbon Fiber Graphite Sheet Packing, purchased from DSN, China), served as a tab for both the cathode and anode. To prevent a short-circuit between the electrodes, a separation was achieved using Celgard and Kapton insulating tape (Bertech Double Sided Kapton (Polyimide) Tape, 0.003 cm thick, 5 cm wide, silicone adhesive on both sides). This tape proved effective in preventing direct contact between two electroactive materials and establishing better contact between different interfaces, contributing to the system's overall performance.

### Design and Fabrication

### Single-Cell

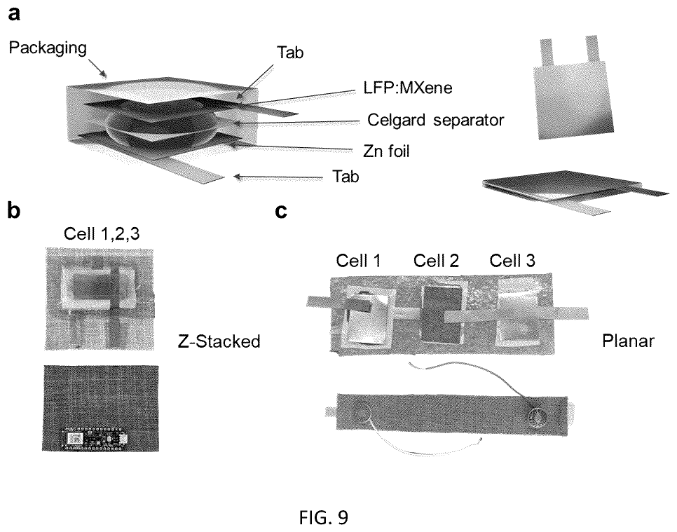

The desired size of the LFP:MXene electrode, Zn foil, and two tabs were prepared prior to device fabrication. A patch was cut into two identical pieces in terms of size and shape-one for the top and the other for the bottom of the pouch, considering the size of the electrodes. One patch piece was placed on a flat surface, e.g., a bench, with the adhesive side facing up. First, the positive tab was placed in the middle of the patch, followed by the LFP:MXene electrode. A few drops of 1 m LiCl 15 m ZnCl₂ gel electrolyte were applied on top of the textile-based electrode making sure it is properly wetted. Subsequently, a piece of Celgard was placed onto it, ensuring it covered the entire electrode area. Finally, first the Zn foil and then, the other tab were placed on top to form a cell stack followed by another piece of the patch, which was shown in FIG. 9a.

### Two and Three Cells in Series

To double or triple the device's operating voltage and make it a usable power supply for most electronic devices, two or three cells with the same electrochemical composition were connected in series. Two different designs were implemented for more than one cell fabrication-stacked and planar. The stacked design (FIG. 9b) utilizes individual cells that are placed on top of each other forming a stack growing in the z direction. This design can be implemented when manufacturing a portable on-body sensor, e.g. for healthcare remote monitoring. On the other hand, in the planar design (FIG. 9c), cells are arranged in the same plane next to each other, creating a thin and conformal design. The application for this configuration can, for example, be a bracelet/wristband for a smartwatch. Both designs imply the use of wearable electronics, optimized and tailored for the best use of an application with regard to the shape, size, and quality of the material packaging. Hence, the packaging was cut accordingly to accommodate the placement of one or few cells accounting for the preferred device design. In the case of the planar design for three cells in series, the first cell was assembled using the procedure for single cell fabrication. The tab on top of the anode served as an electrical connector between the anode and the cathode from the second cell. A new piece of the tab was used by the cathode in the second cell and the anode in the third cell. The circuit was complete once all cells were assembled and connected to each other. Polyimide (Kapton) tape was employed where necessary to prevent electrical and ionic shorting. Furthermore, an accurate indication of both terminals is useful for battery testing and integration with electronic devices. The negative terminal was established by the anode in the third cell, while the positive terminal was determined by the cathode in the first.

Integration with Electronic Devices

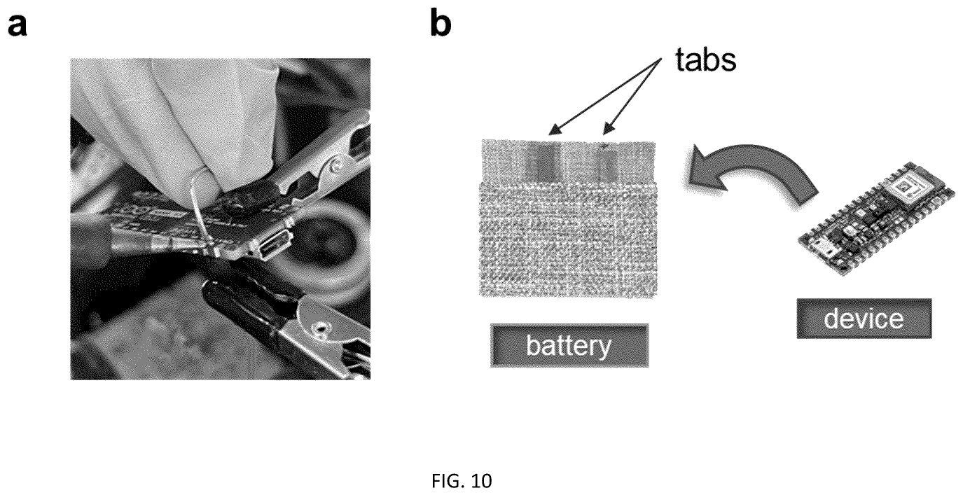

Developing e-textiles that are thin, soft/lightweight, and flexible has been desired by many industries where establishing personalized human interfaces plays an important role, such as healthcare and fitness. The key components of such systems are sensing capabilities, data computation, and wireless data transmission (e.g., Bluetooth, WiFi) for analysis. To prove these e-textiles' viability, sufficient energy and power are required. While current, rigid, LIBs are capable of supplying the current necessary for these functionalities, the ongoing research into textile-based batteries often falls short of the required current supply for such complex electronics. Herein, the main aim of this research was to integrate a flexible ReHAB battery, being in contact with human skin/clothing, with a peripheral electronic device (programmable Arduino with on-chip sensors) for on-body sensor measurements and continuous data collection via Bluetooth. To integrate the fabricated battery with the Arduino, two wires (red and black) were soldered to the pinholes corresponding to the ground (black-negative) and the 3.3 V input (red-positive) on the Arduino board (FIG. 10a). The two soldered wires were subsequently integrated with the exposed tabs of the fabricated battery and then, covered with a piece of the packaging material ensuring a good electrical contact (FIG. 10b). The battery-device integration is further explained herein.

### Results and Discussion

### Material Characterization

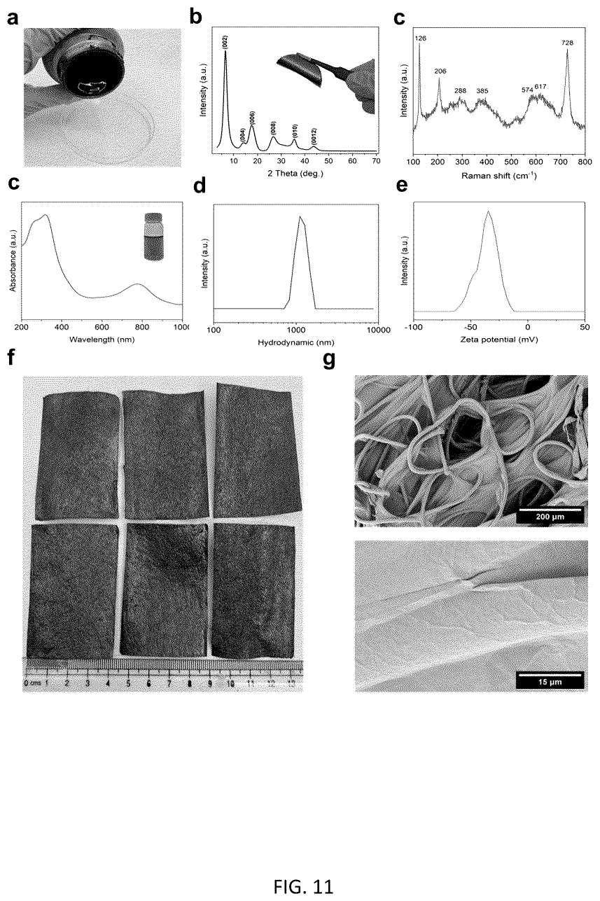

The versatile chemical and structural variety of MXenes along with their unique features, such as conductivity, high surface-to-mass area, specific capacitance, hydrophilicity, and solution processability make good candidates for energy storage applications. In this study, the d-Ti₃C₂Tₓ was initially obtained as a viscous ink (FIG. 11a), later a free-standing film (FIG. 3b), blade-coated film (FIG. 3c), dip-coated MXene textile (FIG. 11f), and finally, a composite solution of different ratios of LFP and MXene (FIG. 5a).

The Al—Ti₃C₂ MAX phase precursor was etched, washed, and finally delaminated through intercalation of Li⁺ to obtain single-layer Ti₃C₂Tₓ flakes. For this work, the solution was concentrated to form an additive-free viscous ink. The XRD pattern was obtained for a free-standing d-Ti₃C₂Tₓ made by vacuum-assisted filtration to confirm the successful removal of A-element from the MAX, and a formation of stacked basal planes structure with a P6₃/mmc space group symmetry. Prior to the collection of the XRD pattern, the filtered film was stored in a vacuum desiccator for 24 h at RT to remove any adsorbed water. The XRD pattern was presented in FIG. 11b. The recorded (002) peak at 6.6° corresponds to 13.3 Å d-spacing. All peaks were identified and attributed to their crystal planes. No impurities or secondary phases were found. Furthermore, the pattern did not show the presence of the MAX phase, which was indicative for a complete etching of the Al layers. The Raman spectroscopy pattern of the obtained Ti₃C₂Tₓ MXene exhibited characteristic peaks around 126, 206, 574, and 728 cm⁻¹ (FIG. 11c), reflecting the material's structural and compositional features and showing good alignment with already published report. Subsequently, a very diluted MXene suspension was placed in a quartz vial to record the absorbance spectra (FIG. 11d). The UV-vis spectra showed a characteristic interband transition peak at 340 nm and a plasmonic peak at 785 nm, which is in agreement with the literature⁵⁴. The dynamic light scattering (DLS) measurement revealed the average value of the hydrodynamic diameter of single MXene flakes, which was approximately 1000 nm (FIG. 11e). Furthermore, the zeta potential was equal to −37.4 mV indicating a stable aqueous dispersion (FIG. 11f). Hence, the obtained MXene inks display good stability. Free-standing Ti₃C₂Tₓ films exhibited conductivities ranging from 10,000 to 15,000 S cm⁻¹, which is strongly influenced by the flake alignment and interflake distance. The same batch of highly concentrated d-Ti₃C₂Tₓ (26.6 mg cm⁻²) served as a solution for cotton substrates dip-coating. The dip-coated MXene textiles with a footprint area of around 24 cm² (FIG. 11g) were characterized with SEM, where the openings corresponding to a porous textile structure, were filled in with the synthesized material. High-magnification images showed 2D MXene nanosheets adhered conformally along the individual fibers (FIG. 11h).

### LFP Electrodes

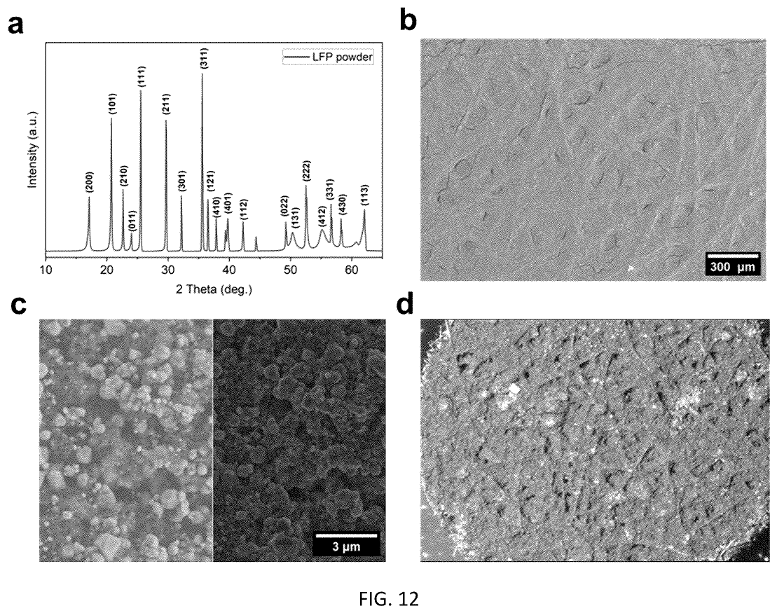

The LFP was pressed onto the silica substrate to perform the XRD measurement. The XRD pattern was in agreement with the one reported in the reference standard JCPDS83-2092 card and MTI specifications. The pure phase of LFP, with an olivine structure indexed to an orthorhombic Pnma space group, showed characteristic prominent sharp peaks. The obtained XRD data was treated, the background was subtracted and the intensities corresponding to signals were normalized to 1 (FIG. 12a). The LFP containing electrodes cast on a CFP substrate were imaged using SEM (FIG. 12b, c) and Keyence (FIG. 12d). The obtained images revealed clearly distinguishable fibers and confirmed the spherical morphology of LFP particles, which had a characteristic white color (overcharging from islands of agglomerates of LFP particles) in the SEM image due to their insulating nature. The backscattered image showed the depth of LFP particles stacking on top of each other. The single particle size ranged from 500 nm to 1 μm, which was in agreement with the supplier specifications. The 70:10:20 electrode was used as a representative sample for the imaging at different magnifications.

### LFP:MXene Composite Electrodes

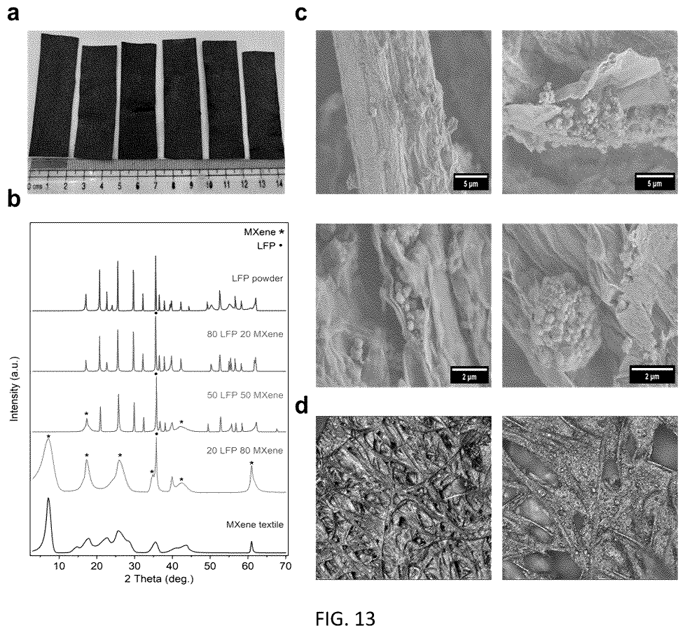

The surface of MXenes is covered with different termination groups leading to an increased colloidal stability in aqueous solutions. After performing a mixed acid synthesis, the redox-active surface termination groups can be described as T=O, —OH, —F, —Cl etc. Additionally, the negative zeta potential-37.4 mV of its solution allows for wide variety of water-based processing methods. This unique property can be utilized while manufacturing materials used for electrochemical energy storage. The majority of conventional routes for electrode manufacturing require the use of hazardous organic solvents, which also increases manufacturing costs and raises environmental concerns. Furthermore, MXenes' ability to intercalate ions in between the interlayer, together with high conductivity and hydrophilic nature, enables their use as conductive binders that do not undergo redox reactions but provide a good pathway for electron flow. For this reason, the widely researched battery material-LFP, acting as insulator, was mixed with MXene ink to form three different composites—20:80, 50:50 and 80:20. The freshly obtained LFP:MXene electrodes (FIG. 13a) were first characterized by the XRD. FIG. 13b presents XRD patterns for samples ranging from highest amount of MXene to lowest (LFP powder). All samples, except for LFP powder, were coated on a textile substrate. Due to the highly porous, textured nature of the samples, a significant peak broadening was observed especially in MXene textile. Moreover, the random MXene flake orientation in a 3D porous structure leads to the disappearance of some highly ordered (001) signals. However, the most characteristic (002) peak, corresponding to the interlayer spacing, is still well preserved. The composites consisting of LFP and MXene exhibited features of both patterns. The increasing amount of LFP resulted in more prominent and sharper LFP peaks and less distinguishable MXene characteristic peaks until their complete disappearance. For example, in the 50:50 and 80:20 samples the (002) peak was not observed. The SEM micrographs along with optical microscopy images for 50:50 samples were presented in the FIG. 13c,d. The 50:50 electrode was used as a representative sample for the imaging. According to previous studies, MXene flakes create a network of interconnected conductive nanosheets wrapped around LFP particles providing a good pathway for the electrons and electrode integrity upon cycling. Herein, the MXene flakes were aligned along the fiber length due to the hydrophilic nature of both cotton and MXene, forming a robust network of 2D MXene nanosheets around the textile-based substrate. In line with previous studies, it was observed that LFP single particles were covered with MXene nanosheets, forming electrical contacts between isolating LFP particles. The majority of LFP particles fell within the size range of 500 nm to 1 μm, accompanied by some agglomerates.

### Binder Stability Test

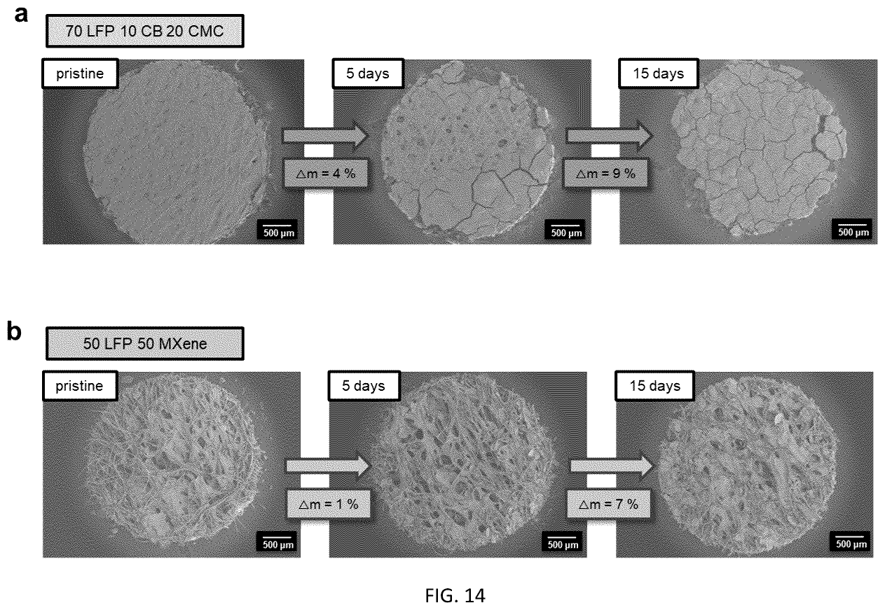

Due to the hydrophilic nature of both MXenes and CMC, there is a concern about the stability of the electrodes prepared using these binders and exposed to an aqueous environment. To address this concern, the electrode stability study over time after immersion in 1 m LiCl 15 m ZnCl₂ WiS electrolyte. After 5 and 15 days, the LFP and LFP:MXene electrodes were taken out of the vials filled with the electrolyte in order to perform electrode microstructure characterization. Although there was no potential applied, the nature of the electrolyte widely affected the electrode integrity maintained by water-based binders, which was shown in FIG. 14. Initially, the electrodes were weighed using a microbalance to see how the mass changed over time and calculate the mass loss (%). In the case of 70:10:20 sample, the initial mass loss (after 5 days) was more significant compared to 50:50, which showed only a minimal decrease. However, after 15 days both samples indicated a higher change in mass, being in agreement with the SEM images. The visual inspection of the whole electrode area was performed with SEM to observe the shape, size, and texture change over the immersion time. First of all, the pristine LFP-containing electrodes were flat and less porous than LFP:MXene samples. Therefore, the material disintegration and cracks were easily visible even after 5 days, resulting in a much harsher influence of the electrolyte. Moreover, with the increasing immersion time, the electrode cracking was more pronounced. On the other hand, the visual appearance of LFP:MXene electrodes did not reveal any observable material loss over time. Although they exhibited a mass change especially after a longer immersion, due to their porous 3D structure it was hardly seen. Finally, the electrode-level cracks have a tremendous influence on the electrochemical performance including cell energy, capacity, and impedance. Crack position and geometrical parameters have a major effect on the overall cell behavior leading to severe disruptions of conductive networks and preventing electrical contact between particles and/or current collector. The observations indicated that MXene is a superior binder for flexible LFP electrodes than CMC.

### Active Material Mass Loading and Conductivity Measurements

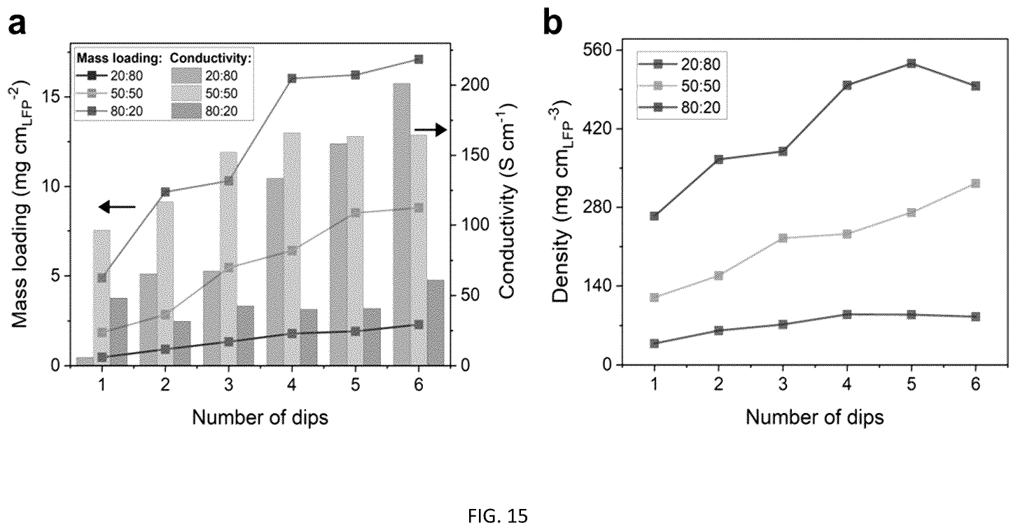

Multiple dip-coatings were performed in order to show the correlation between the mass loading and conductivity with an increasing number of dips (FIG. 15a) and choose the most promising LFP:MXene ratio for the electrodes for wearable applications. The conductivity plays an important role in the electrode architecture since there must be good electrical contact between active material particles. This can be hindered if the active material density in the electrode is too high. Herein, the slurries-compared to the conventional batteries-were not cast on the current collector but they utilized a nonconductive cotton substrate. The textile acts as a scaffold and does not contribute to the formation of an electron percolation network, accounting for an increased contact resistance. The resistance was measured together with the mass loading for all 18 samples—6 dips for each 20:80, 50:50, and 80:20 LFP:MXene ratio. Naturally, the mass loading increased with the higher number of dips for all three ratios. However, the most significant increase was observed for 80:20 samples, which consisted of the highest amount of LFP. On the other hand, the 20:80 showed a remarkably small increase in active material mass loading over the dips. This was further correlated with the active material density in the volume of the textile substrate (FIG. 15b). The relative amount of the conductive component-MXene, compared to the insulating LFP, had also a great influence on the conductivity. Initially, the dip-coating solution infiltrated and covered the inner part of each individual fiber after the immersion. With the higher number of coatings, the conductive pathway was established by the MXene nanosheets that were distinctly exposed to the textile surface. Regarding the nonconductive substrate—each time the contact resistance was calculated, and then subtracted to obtain the true resistance at the fixed 2 cm distance. A significant conductivity increase was observed for the 20:80 samples. However, the 50:50 samples showed a decently high conductivity even in the 1st dip which seemed to stabilize around the 3rd. For this reason, the 50:50 sample was considered the most attractive due to the lowest number of dips required to obtain good conductivity. As for the reference, the conductivity of the 3rd dip for the MXene textile was equal to 650 S cm⁻¹, whereas for the CFP it was equal to only 110 S cm⁻¹.

### Electrochemical Characterization

### LFP Electrodes

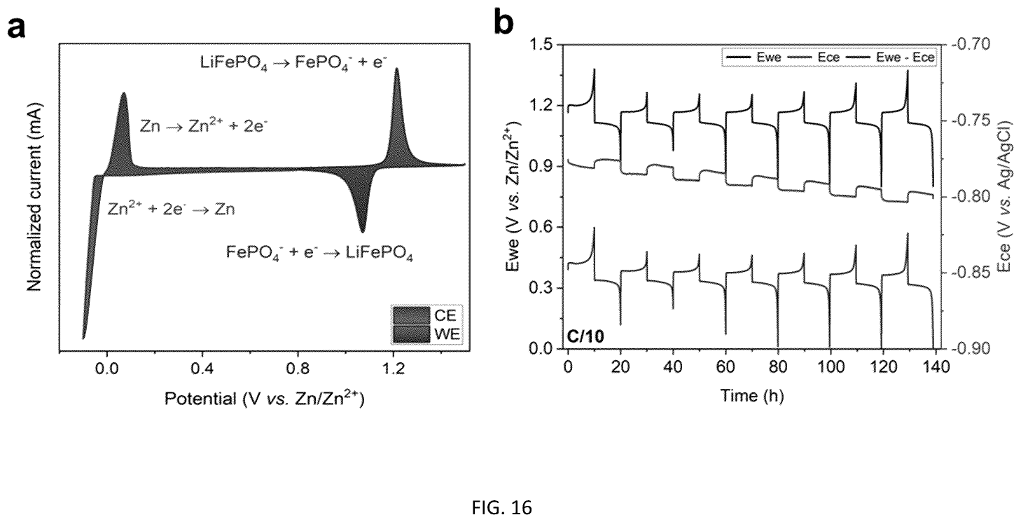

The novel rechargeable ReHAB system—Zn/LiFePO₄, uses two charge carrier ions in the electrochemical mechanism, illustrated in FIG. 16a, where Li⁺ intercalates into LFP on the cathode and Zn²⁺ deposits on the anode. The electrochemical experiments were carried out in a Swagelok cell in the WiS electrolyte-1 m LiCl 15 m ZnCl₂, which brings multiple advantages, such as widening the electrochemical potential window and suppressing OER and HER. New insights of individual electrodes and the cell potentials of Zn²⁺/Li⁺ hybrid aqueous batteries have been investigated using the spectator cell mode (FIG. 16b). The cell setup implies that the Ewe was the cell potential, Ece was the CE potential and Ewe-Ece was the WE potential. The subtraction of CE from the WE resulted in the battery operational voltage, which was equal to 1.2 V.

The electrochemical characterization of Swagelok cells served as a preliminary test for small area electrodes. Taking into account the main goal of this project—designing a textile battery to power real world electronics—the findings from the initial tests were incorporated while the electrodes were scaled up to meet the power and energy requirements. The key metrics, that were taken into account for the electrochemical tests, were the areal capacity (mAh cm⁻²) and the cycling stability.

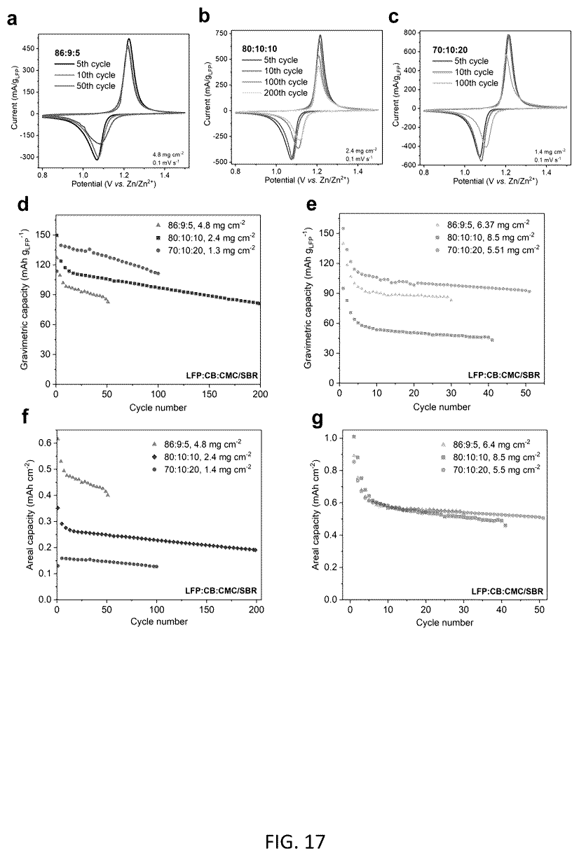

After the electrochemical window determination, the LFP-based electrodes with a varying active material wt %—86:5:9 (FIG. 17a), 80:10:10 (FIG. 17b) and 70:10:20 (FIG. 17c). The presented CV curves carried out at a constant scan rate of 0.1 mV s-1 on low mass loading electrodes (<5 mg_{LFP} cm⁻²) revealed the shapes of the oxidation/reduction peaks and the specific currents (mA/m_{LFP}). The same electrodes and their higher mass loading equivalents electrodes (>5 mg_{LFP} cm⁻²) underwent the same tests in order to determine their gravimetric (FIG. 17d, e) and areal capacities (FIG. 17f, g) and cycling stability. The theoretical capacity of LFP is equal to 170 mAh g⁻¹. Firstly, all cells experienced the capacity drop in the initial cycles. This may be affected by the electrolyte, which could lead to some side reactions and has shown a destructive effect on the electrode integrity. Moreover, this effect could have become more meaningful when the potential was applied, leading to a constant capacity fade over cycles. Secondly, the lower mass loading electrodes showed better gravimetric capacities due to the better electrical pathway for the electrons and better adhesion to the substrate. Based on the results (FIG. 17d, e), the 80:10:10 electrode with 2.4 mg cm⁻² mass loading showed the best gravimetric performance among all the cells. On the other hand, the ones with higher mass loading showed better areal capacities, but their cycle life stability is much shorter. The areal capacity is directly related to the higher amount of active material mass per the electrode area, which results in higher specific currents. Moreover, as previously mentioned, wearable applications are constrained by the garment area, thus higher areal capacities are of greater importance. Finally, the purpose of this study was to establish a trade-off between a good areal capacity and cycling stability.

### LFP:MXene Composite Electrodes

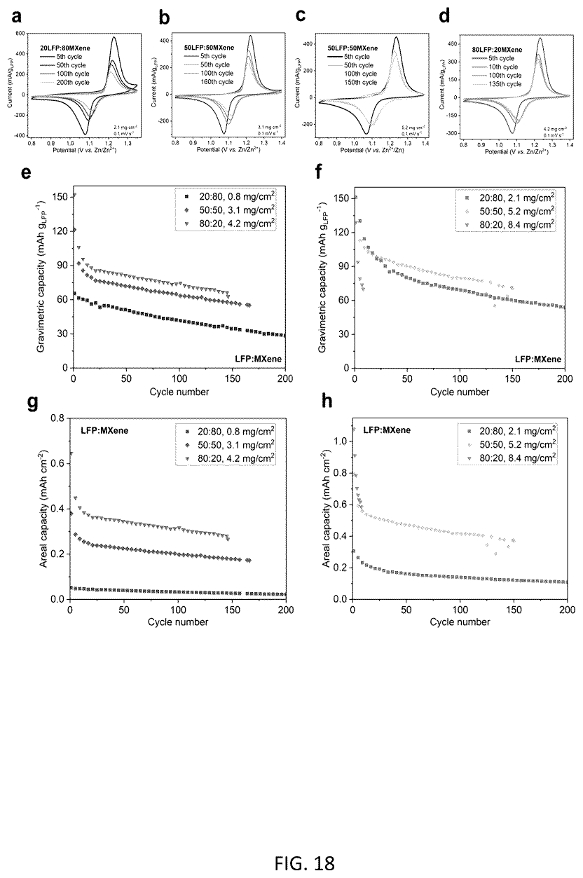

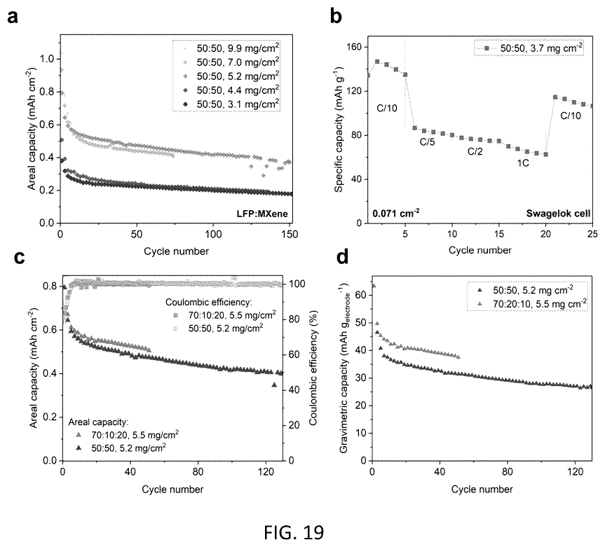

The same characterization was performed for LFP:MXene electrodes with varying active material wt %—20:80 (FIG. 18a), 50:50 (FIGS. 18b, c) and 80:20 (FIG. 18d) to compare the shape of oxidation/reduction curves to LFP containing electrodes and their electrochemical performance with regard to gravimetric and areal capacity. With the increasing amount of MXene, the CV shape becomes more bulky and capacitive-like especially at the cut-off potentials. This could be due to the high surface area of MXene flakes, which is negatively charged and thus, tends to electrostatically attract ions and store charge. Herein, compared to LFP containing cells, the electrodes with lower mass loading (FIG. 18e, g) performed worse, especially the 20:80 sample. This may be due to the large amount of pseudocapacitive MXene nanosheets, which due to the applied potential range, store ions at the electrical double layer only and may hinder the intercalation of Lit into the positive electrode. Furthermore, there may be some structural/electrostatic constraints due to the random orientation of MXene flakes in the textile substrate, leading to a limited phase-boundary diffusion of the Lit. On the other hand, the 50:50 and 80:20 electrodes, where the LFP relative mass was much higher, have shown a better performance. The higher mass loading electrodes have shown better both gravimetric and areal capacities. Unfortunately, high mass loading (6.4 mg cm⁻²) 80:20 electrode failed right after few cycles. This may be influenced by a much higher density of the active material, together with an insufficient electronic conductivity and mechanical integrity within the electrode (FIG. 15a). As a result, the 50:50 ratio, has not only shown good conductivity values at lower number of dips, but also the best areal performance for a higher mass loading electrode. For this reason, 50:50 electrodes with different mass loadings in the range from 3 to 10 mg cm⁻² were assembled and tested. The obtained areal capacity results were presented in FIG. 19a. Based on these results, the electrode with 5.2 mg cm⁻² exhibited the best performance. The electrodes with higher mass loading might have become too dense for the electrolyte to fully wet them and access all active material particles. This could lead to an increased cell resistance and would greatly influence their cyclability. Additionally, at a certain threshold, the mass loading will affect the mechanical integrity and particle distribution in the electrode as well. The rate test of 50:50 electrode with 3.7 mg cm⁻² mass loading showed how the gravimetric capacity changed depending on the applied current (FIG. 19b). The cell experienced an initial capacity loss after switching from C/10 to C/5 rate, which became less significant in the following rates—C/2, 1C. After that, the C/10 rate was applied again and the cell's capacity increased but did not reach the same initial capacity. Finally, in FIG. 19c, d, the performance of 50:50 and 70:10:20 electrodes with similar mass loadings were compared. The areal capacity, coulombic efficiency and the gravimetric capacity per electrode mass were plotted vs. the cycle number to address the key electrochemical metrics for wearable applications. The 70:10:20 cell showed a higher areal and gravimetric capacity per electrode in the initial cycles, but lower overall cycling stability compared to the MXene-containing electrode.

### Textile-Based Device-Fabrication and Integration

### Electrochemical Performance

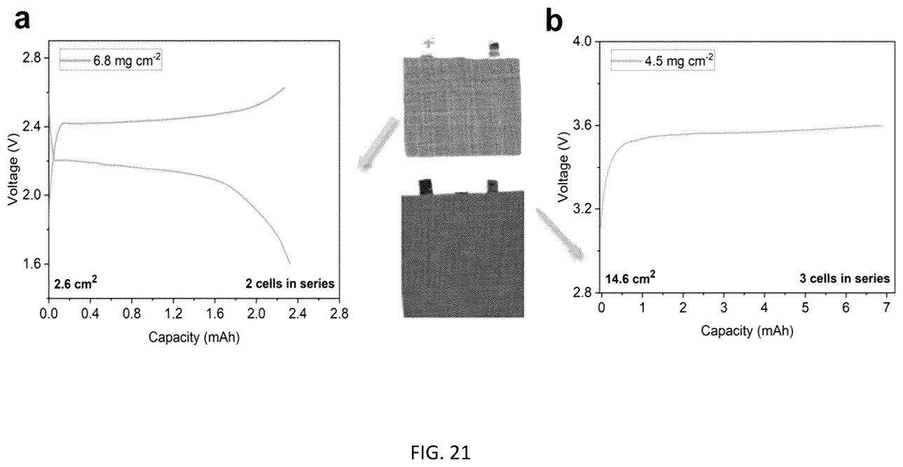

The initial step toward fabricating a flexible battery integrated with a wearable sensing platform was to scale up the electrode area from Swagelok cells (0.071 cm²) and assemble a pouch cell. The electrodes used in this part of the study had mass loadings ranging from 3 to 7 mg cm⁻². According to the Swagelok cell data, this range delivered the most favorable results in terms of cycling stability and areal capacity. Individual pouch cells were assembled to evaluate and compare their electrochemical performance considering their size and mass loading. This evaluation was conducted prior to arranging two or three cells in series. For all cells, Galvanostatic Charge-Discharge tests (GCD) were applied with low C-rates (equal to or below C/10). This rate corresponds to a 10-hour charge and a 10-hour discharge, directly linked to the active material's quantity. The primary challenge encountered with these batteries featuring larger electrodes was the elevated internal resistance. Lower C-rates facilitated a slower diffusion of electroactive species during intercalation and deintercalation mechanisms. FIG. 21a illustrates two different cells with the same active material mass loading (3.2 mg cm⁻²) and very similar footprint area (2.6 and 2.8 cm²). The recorded capacity (mAh) was almost identical for both cells amounting to 1 mAh at the same C-rate. This outcome indicated a good repeatability and reliability of the obtained results. Moreover, two other cells were assembled with the mass loading differing by a factor of 2.2, yet, sharing the same footprint area (2.6 cm²) and cycling conditions (FIG. 21b). The cell with the higher mass loading exhibited a capacity 2.5 times greater (2.5 mAh), which was linked to the amount of the active material per electrode surface area. The final test conducted on the individual pouch cell was a rate test (FIG. 21c). Herein, the cell did not reach the theoretical capacity but experienced a substantial capacity loss when subjected to higher current loads. However, the cell demonstrated recovery once the current was lowered to a value corresponding to the C/10 rate.

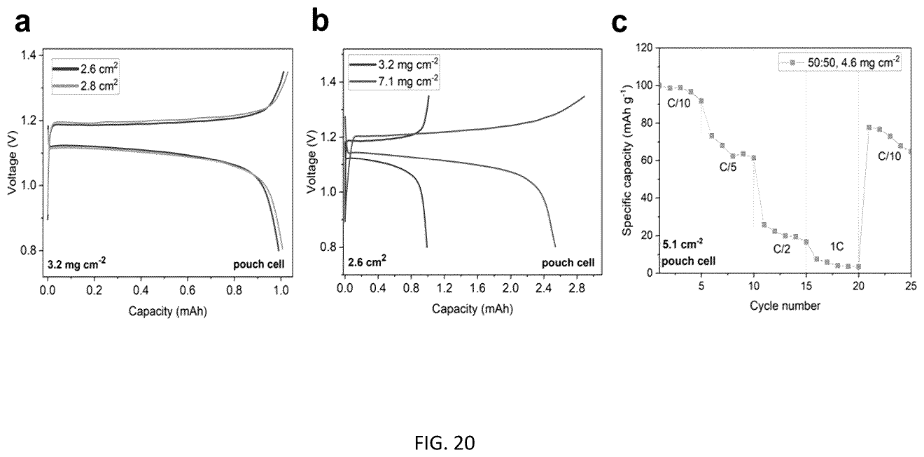

After the successful assembly of individual pouch cells, the next objective was to connect two and three cells in series and record their electrochemical performance. This configuration implies that the cell capacity should remain constant, due to the same value of applied current, while the voltage (depending on the number of cells used) should double or triple. Two identical electrodes (2.6 cm² electrode area and 6.8 mg cm⁻² mass loading), assembled in series, delivered 2.4 mAh of capacity (FIG. 21a), which agreed with the pouch single cell data. Based on its E vs. t charge and discharge curves, the energy density was equal to 2.43 and 1.75 mWh cm⁻², respectively. The device footprint area was identical to the one in FIG. 20b featuring a very similar mass loading (two cells—6.8 mg cm⁻², one cell—7.1 mg cm⁻²). The capacity obtained in both cases was nearly identical, which was relevant to the concept of connecting cells in series. Lastly, three cells were combined to obtain a 3.6 V battery. The pouch cell comprising 3 individual cells connected in series, delivered a capacity of 7 mAh with the device footprint area of 14.6 cm² and 4.5 mg cm⁻² active material mass loading (FIG. 21b). Following a successful charging process, the stored energy was later used to show proof of concept and power the first device-Casio LCD watch.

Integration with Electronics

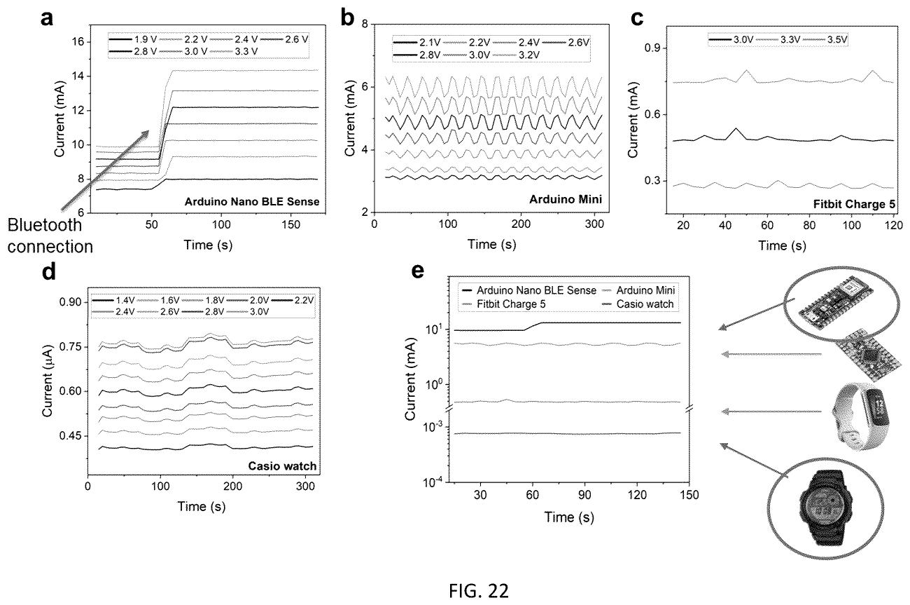

The power consumption of various electronic devices undergoes significant changes based on their abilities and functionalities. For this reason, prior to integrating any peripherical hardware electronics with a power supply, it is essential to understand their specific requirements by performing potentiostatic tests. This technique maintains a constant applied voltage while recording the corresponding current response from the device. This approach helps in assessing the device's behavior and requirements regarding the energy use, which also helped to understand how does the current draw affect the battery's discharge performance (FIG. 22a-e).

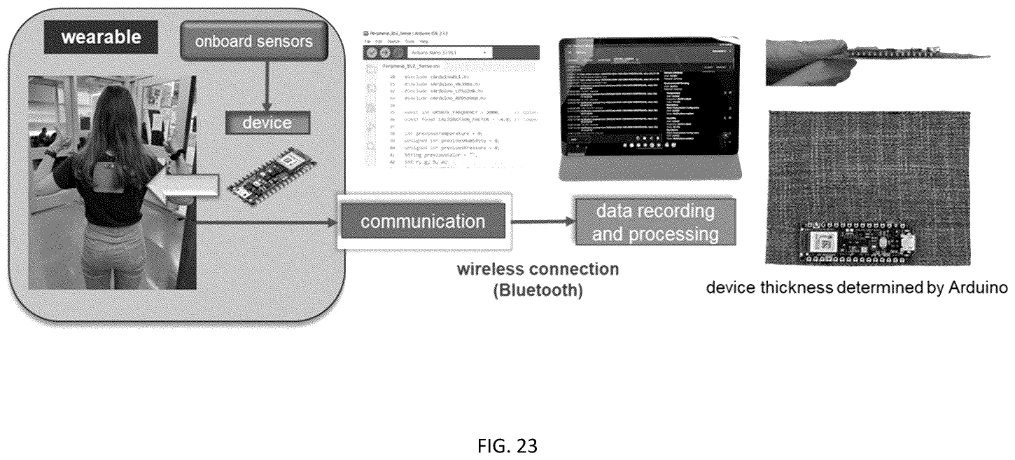

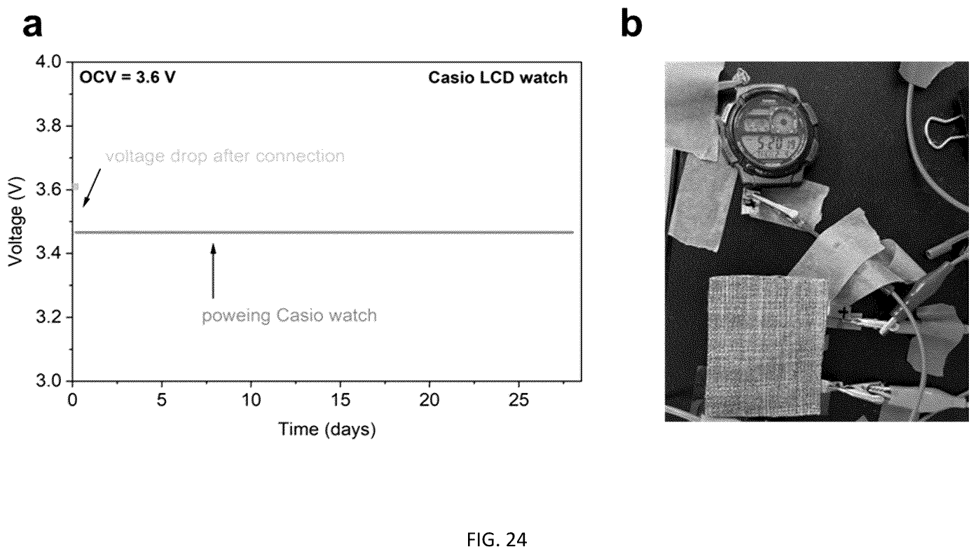

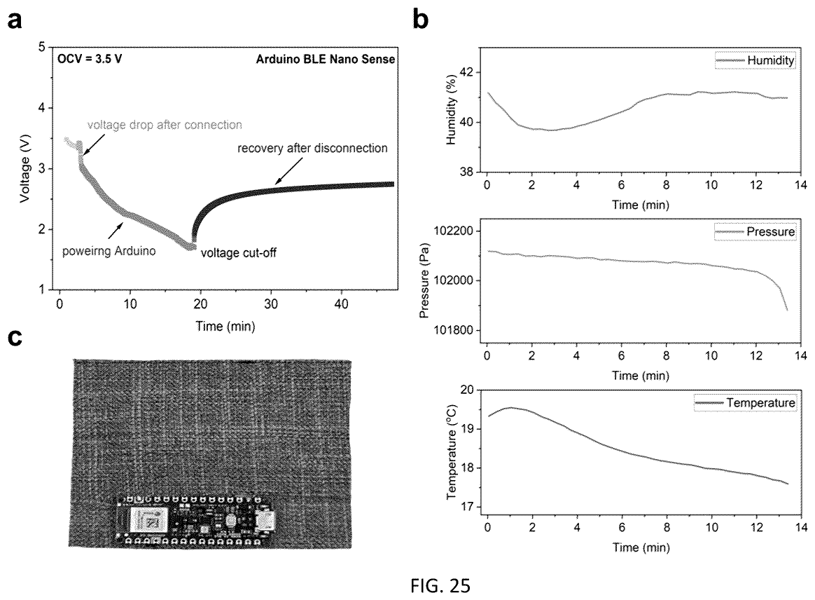

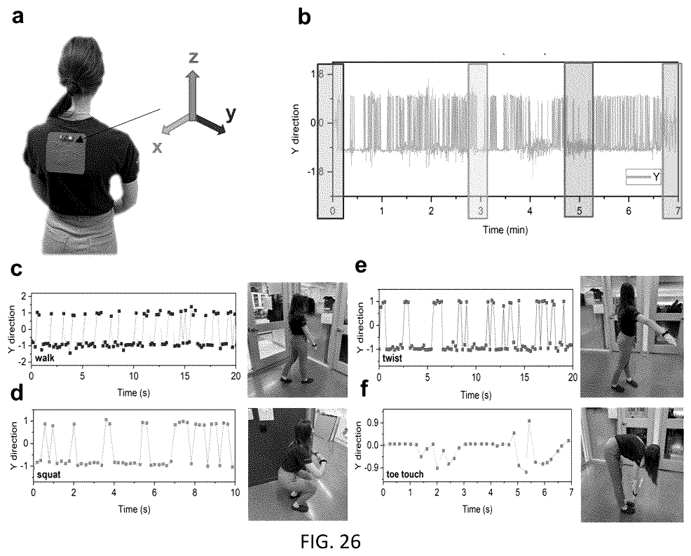

Based on the experimental results, the devices, depending on their capabilities, show a tremendous difference in current draw, which can be different by 4 orders of magnitude—from <1 μA (Casio LCD watch) to >10 mA (Arduino Nano BLE Sense). Arduino, being a peripheral hardware electronic device, can be programmed to receive and send data from its on-chip sensors located on the board. Microcontrollers capable of sensing, data processing, and data collection are desirable for fully integrated e-textiles. With this in mind, a “patch battery” was fabricated. To make the “patch battery”, three cells were placed in series onto a textile patch and enclosed, leaving an exposed area of the patch to mount the electronics. The patch can then be applied to garments and be worn as an all-in-one powered device (FIG. 23). Moreover, the ease of switchability from one electronic device to another makes this solution extremely viable for many different types of sensors and applications. This design was initially used to power an LCD watch to show proof of concept (FIG. 24), then an Arduino Nano BLE Sense for environmental sensing (FIG. 25), and lastly Arduino Nano BLE IoT to create a wearable sensing platform for motion tracking (FIG. 26).

As a proof of concept, the LCD Casio watch was powered and the OCV change of the battery was collected during real-time device operation (FIG. 24). Accordingly, the chronopotentiostatic test was conducted to record the changes in the voltage curve before, in the moment and after the integration, without applying any current or voltage (as shown in FIG. 24a). The OCV of the charged battery was initially equal to 3.5 V. The instant voltage decrease was attributed to the IR drop (ohmic drop), due to high internal resistance from the large electrodes and the in-series connections. Moreover, the discharge voltage curve remained flat, which is a characteristic feature for LFP-based batteries. The watch has been uninterruptedly powered for 28 days (FIG. 24b). The minimal current draw enabled the cell to maintain a stable voltage during the discharge. Supposedly, the current distribution within the whole electrode volume during Lit insertion processes was well distributed. In this case, the integration with the LCD watch was carried out solely for the purpose of recording voltage change, not to demonstrate the real-world applicability of the portable sensing platform. Nonetheless, the presented design was able to power this relatively low current device for over a month, demonstrating its validity. However, the power requirements for more complex devices are considerably higher (FIG. 22d). With this in mind, two different Arduinos, mentioned above, were set out to be powered.

The fully charged battery with 7 mAh capacity (FIG. 21b) was integrated with Arduino Nano BLE Sense to collect environmental data (FIG. 25a, c). Around the third minute, upon completing the battery-device integration, an immediate voltage drop was observed. Following the IR drop, the steep discharge curve was present due to a high current load of around 10 mA. The voltage continued to decrease until the minimum voltage required for device operation was reached. The high current load hinders diffusion-limited processes and leads to a rapid insertion of Lit onto the electrode surface, which as a result becomes saturated when the cell is discharged. This information is directly correlated with the experimentally recorded OCV data. Nonetheless, once a wireless Bluetooth connection with an external consumer electronic equipment (in this case-tablet) was established, the data collection started. The integrated sensor data including humidity, pressure, and temperature was recorded for 13 minutes and can be found in FIG. 25b. The cut-off voltage for Arduino Sense was equal to 1.7 V, however, according to data presented in FIG. 22a, it should have been 1.9 V. This discrepancy might be related to the fact that more complex electronics undergo a boot sequence that requires a higher voltage then continuous operation. By doing the initial testing of power consumption at constant voltage this was not compensated for. Upon removing the current load, the battery's OCV began to recover due to the remaining Li⁺ that did not undergo the discharge due to kinetic limitations under the large discharging current. The conclusion of this test was that the four orders of magnitude difference in current drawn by these two different devices had a tremendous effect on the cell's discharge characteristics and its power and energy delivery capabilities.

It is noteworthy to mention that integrating the battery with an electronic device without a proper battery management system (BMS) and cut-off mechanisms (like cut-off field effect transistors, FETs) can have a detrimental effect to both the battery and the device. Features like voltage and current regulation in cases where there is an output mismatch between the battery's power capabilities and the device's power requirements could be very beneficial. Implementing these features helps to avoid damage to the entire electrical circuit and its individual components and ensures proper device operation along with longer powering times.

### Sensor Data Output

Wearable sensor technology has progressively expanded its practicality across a diverse array of applications. Personal sensor data collected through wearable sensors can deliver important information customized to its user's lifestyle and preferences, such as heart rate, sleep quality, and motion activity. Their superiority relies on patient health monitoring, rapid assistance with disease diagnosis, and enhanced patient outcomes.

Due to the successful integration of the battery with the peripheral electronic device possessing sensing capabilities, the resulting sensor data was gathered and visually presented in FIGS. 25b and 26b-f. Specifically, FIG. 25a showcases environmental sensor data characterized by three distinct metrics: humidity, pressure, and temperature. These sensors were engaged in instantaneous data collection over a span of 13 minutes. Additionally, for the actual demonstration purposes of a wearable sensing platform, the battery was integrated with an accelerometer sensor and worn to capture activity-related data transmitted in real-time (FIG. 26a, b). Throughout the operational sensor time, a range of activities were performed, including walking (FIG. 26c), squatting (FIG. 26d), arm twisting (FIG. 26e), and toe touching (FIG. 26f). The acquired data has been presented, highlighting variations in the Y direction related to the specificity of motion of each activity providing a characteristic and distinct pattern.

### Next-Generation Batteries

The battery industry is a rapidly developing field with emerging new directions aiming for the improvement of the current technologies. The need for batteries that are both lighter and exhibit higher volumetric energy led to new battery designs—the anode—and recently also, cathode—free batteries-eliminating the need for the anode and cathode active materials at the cell assembly stage. Instead, these batteries are equipped with a bare current collectors or inactive additives, such as hosts and coatings. Although these two battery concepts are still at the experimental and developmental level, they attract wide attraction in the battery field due to higher energy density, improved safety and possible lower processing costs.

The ease in MXene ink processability and tunability, depending on the desired form factor or application, makes them appealing for passive components in a battery. Porous MXene textile and MXene thin film were utilized as hosts for zinc-ion and iodide complex deposition. Moreover, their high electronic conductivity, robustness, high surface area, and lightweight nature render them attractive for candidates for next-generation batteries.

### Anode-Free System

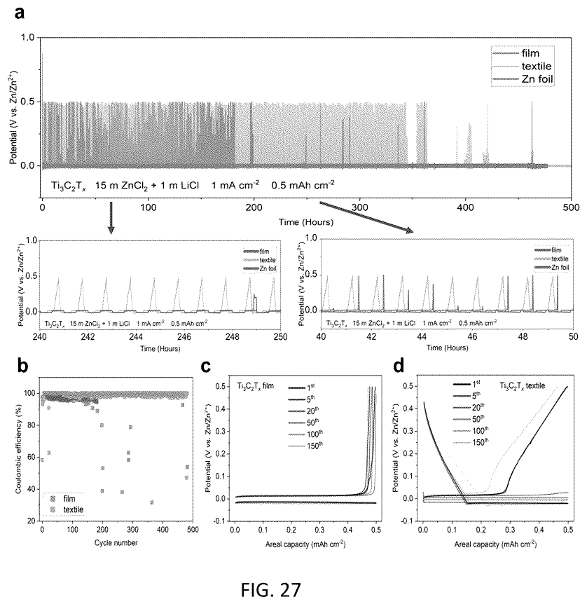

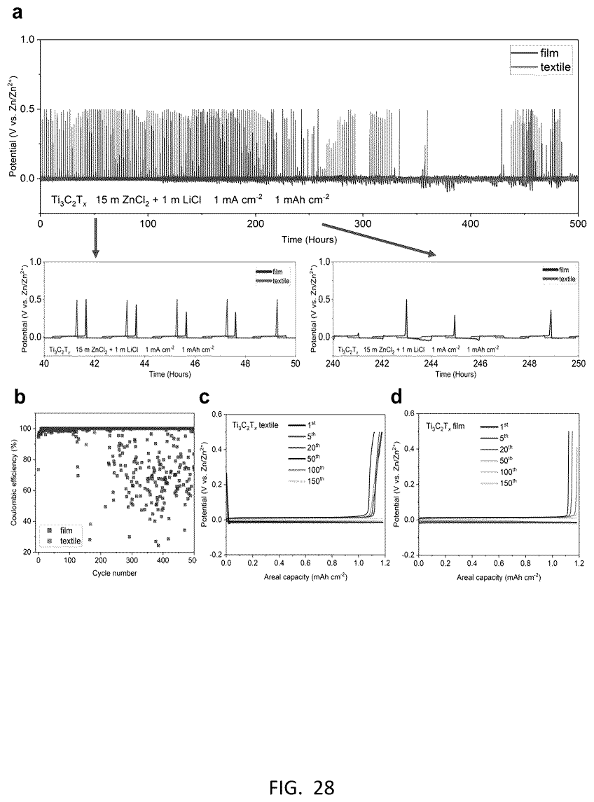

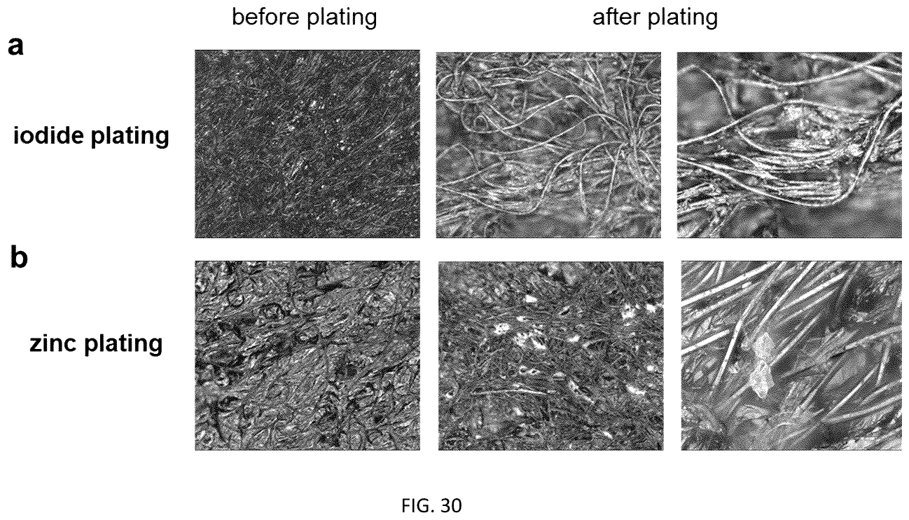

The 2-cell setup for Zn plating/stripping on the Ti₃C₂Tₓ MXene consisted of WE-MXene textile or MXene film and Zn foil counter and pseudo-reference. The galvanostatic test for the Zn∥Ti₃C₂Tₓ cell, was carried out at a current density of 1 mA cm⁻² and it was limited by the time—30 minutes (FIG. 27) or 1 hour (FIG. 28)—for the Zn deposition as it is a time limited process, and potential, 0.5 V for the stripping as it is a capacity limited process. The cells ran for 500 hours in both cases, which corresponded to 1000 and 500 deposition cycles, respectively (FIG. 27a, FIG. 28a). The Coulombic efficiency in both cases was at the level of around 100% for the cells containing a Ti₃C₂Tₓ MXene textiles, whereas the films experienced a significant efficiency loss after around 150 cycles in both conditions (FIG. 27b, FIG. 28b). This might be related to the material porosity, texture, and spatial dimensions since MXene textile resembles more of a 3D structure, compared to a 2D flat and thin film. The difference in the area of the host structure could largely affect the quality of Zn deposition. The 2D films possess a large surface area, but not the volume, leading to a more planar and possibly faster growth of Zn on top of their surface. The porosity of the 3D textiles, defined by the total volume of void space within a specified area, could result in an eventual suppression of the dendrite growth in the latter cycles. The film after 1 hour of deposition exhibited a much worse performance in terms of coulombic efficiency compared to the 30 minute deposition. A close-up look at 40-50 and 240-250 hours of plating/stripping in both conditions was presented underneath the panel (a). While both films and textiles experienced a very low polarization, equal to the one corresponding to the symmetrical Zn∥Zn cell, their shapes of subsequent charge-discharge curves were distinctly different in 30 minute (FIGS. 27c, d) and 1 hour deposition times (FIG. 28c, d). Surprisingly, the textile cell with shorter plating/stripping time has shown a supercapacitor-like behavior at the beginning of most deposition cycles. The typical triangle corresponding to ion adsorption at the electrical double layer can be related to textile porosity and intrinsic MXene features—a negatively charged surface, covered with many different group terminations as well as a large surface-to-mass ratio. More interestingly, this phenomenon was only observed in the first 10 minutes of deposition but also in the last 10 minutes of stripping in the cell where the deposition time took 30 minutes. This may be primarily related to the electrolyte filling in at the initial stage and flowing out of the pores at final stage. The textile cell with a longer deposition time exhibited a typical plating/stripping behavior. The plating images obtained from the optical microscope are presented in FIG. 30b.

### Cathode-Free System

A dual plating battery delivered a very high areal capacity of 4 mAh cm⁻² when plated onto CFP current collector in a 5 m KI 15 m ZnCl₂ WiS. The battery operates based on two deposition reactions—Zn/Zn²⁺ and electronically insulating I₂/[ZnIₓ⁻(OH₂)₄₋ₓ]^{2-x} with the redox potential at 1.2 V Zn/Zn²⁺. Herein, the CFP current collector was replaced first by Ti₃C₂Tₓ MXene film and then, Ti₃C₂Tₓ MXene textile. The ultimate objective was to create a cathode-free anode-free battery, where MXene acts as a host for both deposition reactions.

Herein, the 2-cell setup for dual plating consisted of Ti₃C₂Tₓ MXene film WE and Zn foil CE and pseudo-reference. The galvanostatic test for the Zn∥Ti₃C₂Tₓ cell was carried out at a current density of 0.3 mA cm⁻² and was limited by the potential—1.25 V in the charge and 0.8 V in the discharge. The charge-discharge curves exhibited an areal capacity in the range from 2.0 to 2.5 mAh cm⁻² at the selected cycles, which unfortunately was lower than the one presented in the aforementioned paper (FIG. 28a). Having this in mind, it can be concluded that iodide does not get trapped in between MXene flakes, but surface only. The discrepancy in discharge and charge capacity led to a poor CE, which remained only at around 60% over 40 cycles (FIG. 28b). Two cells consisting of no active materials, just MXene-based hosts, were assembled in order to compare the shape of the CV curve at 0.1 mV s⁻¹ at the 5th cycle with regard to the material structure. The first cell comprised of MXene textile WE and MXene film CE showed redox activity in the 0.8-1.25 V range with a sharp plating and broad stripping peak. On the other hand, the second cell with MXene textile WE and CE exhibited more prominent redox peaks and a more bulky/capacitive-like behavior in the non-redox active potential due to the 3D MXene textile structure attracting a greater amount of ions and water molecules. The possible issues related to charge imbalance may affect cell performance. The plating images obtained from the optical microscope were presented in FIG. 30a.

### Aspects

The following Aspects are illustrative only and do not limit the scope of the present disclosure or the appended claims. Any part or parts of any one or more Aspects can be combined with any part or parts of any one or more other Aspects.

Aspect 1. An energy storage cell, comprising: a layer comprising a plurality of fibers, the plurality of fibers having a MXene material disposed thereon; an electrolyte contacting the layer; a first conductor in electronic communication with the electrolyte; and a second conductor in electronic communication with the electrolyte.

A layer can, in some embodiments, comprise an amount of an electrochemically active component. Such an electrochemically active component can be, for example, lithium iron phosphate (LFP), which can undergo lithium intercalation/deintercalation. Without being bound to any particular theory or embodiment, a layer can comprise fibers having a MXene and an electrochemically active component disposed thereon, for example via coating. A layer can also include additional materials, for example, thickeners, binders, and other materials.

Without being bound to any particular theory or embodiment, an example energy storage cell is depicted in FIG. 9. As shown, a cell can include packaging, which can be a fabric or other packaging. A conductive portion—e.g., the lower tab shown in FIG. 9a—can be present.

A first electrode, which can comprise fibers, MXene, and an electrochemically active component—can be placed into electronic communication with the conductive portion. In some embodiments, the electrode physically contacts the conductive portion.

An amount of electrolyte can be placed into contact with the electrode. A separator—which can be Celgard, fabric, or other material, as shown—can be placed into contact with the electrolyte. A further amount of electrolyte can in some embodiments be placed on the separator, followed by a further electrode.

As shown in FIG. 9A, the further electrode can be Zn foil, but this is not a requirement, as the further electrode can be another metal and can also be a MXene-comprising electrode. The further electrode can be of the same material as the first electrode, although this is not a requirement, as the further electrode can comprise different materials than the first electrode. As but one example, the further electrode can comprise a fabric having MXene infiltrated therein but without the presence of an electrochemically active material. As another example, the further electrode can comprise a fabric having MXene infiltrated therein along with an electrochemically active material.

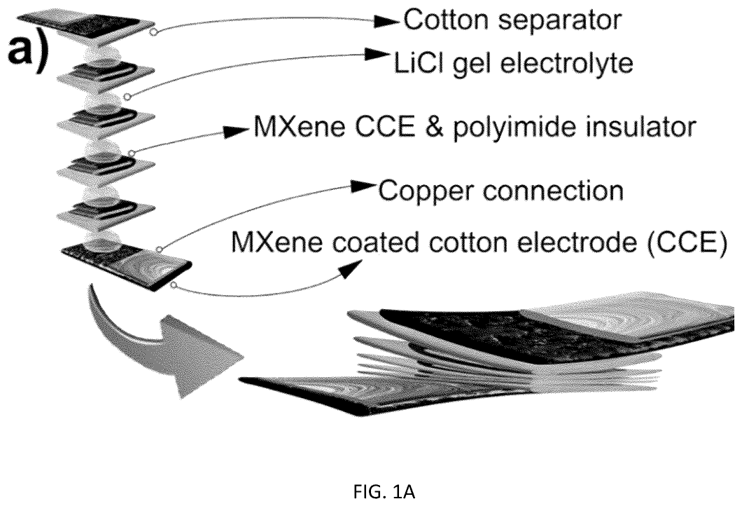

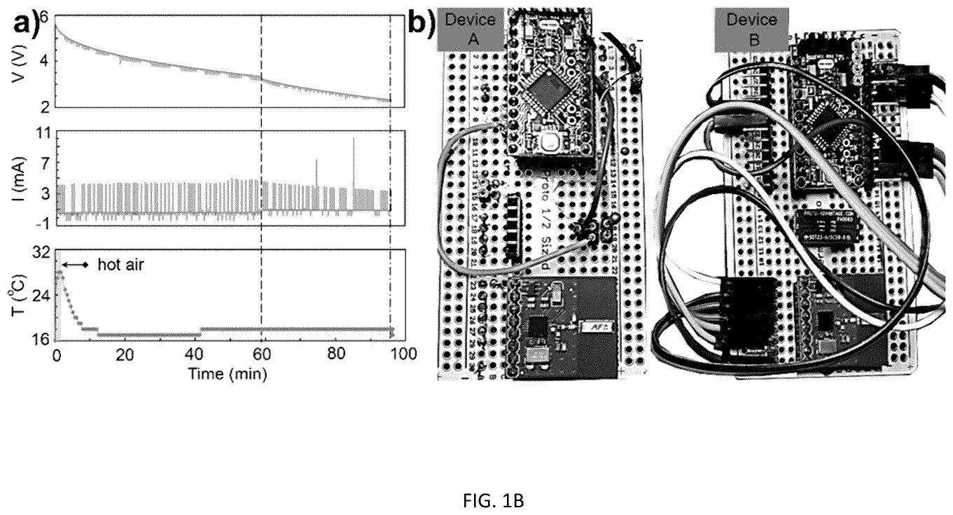

As shown in FIG. 1A, an electrode can be a single sheet, but can also be folded, for example, in a C-fold or other fold configuration. An insulator can be placed within the fold to prevent parts of an electrode from touching other parts of an electrode.

Aspect 2. The energy storage cell of Aspect 1, further comprising a separator, the separator optionally pervious, the separator contacting the electrolyte.

Aspect 3. An energy storage device, the energy storage device comprising at least one energy storage cell according to any one of Aspects 1-2.

Energy storage cells can be arranged in a planar fashion, as shown in FIG. 9c. This is not a requirement, however, as energy storage cells can also be arranged in a stacked fashion, as shown in FIG. 9b. As but one example, a device can comprise at least one energy storage cell that is superposed over another one (or more) energy storage cells. A device can include a plurality of energy storage cells according to the present disclosure. As but one example, a device can include 2, 3, 4, 5, 6, 7, 8, 9, or 10 such energy storage cells.

One energy storage cell can be in electronic communication with another energy storage cell; in some embodiments, all energy storage cells of a given device are in electronic communication with one another. This is not a requirement, however, as a device can include a first bank of energy storage cells that are in electronic communication with one another and a second bank of energy storage cells that are in electronic communication with one another. The first and second banks of energy storage cells can be in electronic communication with one another, but this is not a requirement, as the first bank of energy storage cells can be electronic isolation from the second bank of energy storage cells. The first and second banks of energy storage cells can be in interruptible electronic communication with one another.

Aspect 4. The energy storage device of Aspect 3, wherein the energy storage device comprises a plurality of energy storage cells according to Aspect 1.

Aspect 5. The energy storage device of Aspect 4, wherein one of the plurality of energy storage cells is superposed over another of the plurality of energy storage cells.

Aspect 6. The energy storage device of Aspect 3, wherein the energy storage device is comprised in a garment. The garment can comprise, for example, a shirt, a jacket, pants, robe, coverall, a scarf, a hat or other headwear, a shoe, a sock, and the like, as well as parts of garments, such as sleeves and legs.

Aspect 7. The energy storage device of Aspect 3, wherein the energy storage device is comprised in a wearable article. Such an article can be, for example, a watch, a bracelet, a necklace, and the like.

Aspect 8. The energy storage device of Aspect 3, wherein the energy storage device powers an electronic device. Such a device can be any one or more of a computing device or a sensor.

Aspect 9. The energy storage device of Aspect 8, wherein the energy storage device and the electronic device are comprised in the same article. As but one example, the energy storage device and the electronic device can be comprised in a jacket.

Aspect 10. The energy storage device of Aspect 9, wherein the article is a garment. Example garments are described elsewhere herein and include, for example, a shirt, a jacket, pants, robe, coverall, a scarf, a hat or other headwear, a shoe, a sock, and the like, as well as parts of garments, such as sleeves and legs.

Aspect 11. The energy storage device of Aspect 9, wherein the article is a wearable device. Such an article can be, for example, a watch, a bracelet, a necklace, and the like.

Aspect 12. The energy storage device of Aspect 8, wherein the electronic device comprises any one or more of a sensor or a computing device. Computing devices can include, for example, mobile communications devices, such as smartphones and smartwatches.

Aspect 13. The energy storage device of Aspect 12, wherein the sensor comprises any one or more of a temperature sensor, a positional sensor, or an inertial sensor.

Aspect 14. The energy storage device of Aspect 13, wherein the sensor is an inertial sensor.

Aspect 15. The energy storage device of Aspect 13, wherein the sensor is a positional sensor.

Aspect 16. The energy storage device of Aspect 13, wherein the sensor is a temperature sensor.

Aspect 17. A method, comprising charging or discharging a cell according to Aspect 1.

Aspect 18. The method of Aspect 17, wherein the method comprises discharging a cell according to Aspect 1.

Aspect 19. The method of Aspect 18, wherein the discharging is effected to power a device.

Aspect 20. The method of Aspect 19, wherein the device comprises any one or more of a sensor or a computing device.

What is claimed:

1. An energy storage cell, comprising:
a layer comprising a plurality of fibers, the plurality of fibers having a MXene material disposed thereon;
an electrolyte contacting the layer;
a first conductor in electronic communication with the electrolyte; and
a second conductor in electronic communication with the electrolyte.

2. The energy storage cell of claim 1, further comprising a separator, the separator optionally pervious, the separator contacting the electrolyte.

3. An energy storage device, the energy storage device comprising:
at least one energy storage cell, the energy storage cell comprising
(a) a layer comprising a plurality of fibers, the plurality of fibers having a MXene material disposed thereon;
(b) an electrolyte contacting the layer;
(c) a first conductor in electronic communication with the electrolyte; and
(d) a second conductor in electronic communication with the electrolyte.

4. The energy storage device of claim 3, wherein the energy storage device comprises a plurality of energy storage cells.

5. The energy storage device of claim 4, wherein one of the plurality of energy storage cells is superposed over another of the plurality of energy storage cells.

6. The energy storage device of claim 3, wherein the energy storage device is comprised in a garment.

7. The energy storage device of claim 3, wherein the energy storage device is comprised in a wearable article.

8. The energy storage device of claim 3, wherein the energy storage device powers an electronic device.

9. The energy storage device of claim 8, wherein the energy storage device and the electronic device are comprised in the same article.

10. The energy storage device of claim 9, wherein the article is a garment.

11. The energy storage device of claim 9, wherein the article is a wearable device.

12. The energy storage device of claim 8, wherein the electronic device comprises any one or more of a sensor or a computing device.

13. The energy storage device of claim 12, wherein the sensor comprises any one or more of a temperature sensor, a positional sensor, or an inertial sensor.

14. The energy storage device of claim 13, wherein the sensor is an inertial sensor.

15. The energy storage device of claim 13, wherein the sensor is a positional sensor.

16. The energy storage device of claim 13, wherein the sensor is a temperature sensor.

17. A method, comprising charging or discharging a cell according to claim 1.

18. The method of claim 17, wherein the method comprises discharging the cell.

19. The method of claim 18, wherein the discharging is effected to power a device.

20. The method of claim 19, wherein the device comprises any one or more of a sensor or a computing device.
